(19) United States
(12) Patent Application Publication
(10) Pub. No.: US 2022/0327432 A1
(43) Pub. Date: Oct. 13, 2022

(54) INTERVALS USING TRAINED ARTIFICIAL-INTELLIGENCE PROCESSES

(71) Applicant: The Toronto-Dominion Bank, Toronto (CA)

(72) Inventors: Jahir Mauricio GUTIERREZ BUGARIN, Toronto (CA); Tingke Shen, Vancouver (CA); Ka Ho Yenson Lau, Toronto (CA); Maksims Volkovs, Toronto (CA); Tomi Johan Poutanen, Toronto (CA)

(21) Appl. No.: 17/715,861

(22) Filed: Apr. 7, 2022

Related U.S. Application Data
(60) Provisional application No. 63/173,143, filed on Apr. 9, 2021.

(51) Int. Cl. G06N 20/20

(52) U.S. Cl. CPC G06N 20/20

(57) ABSTRACT

The disclosed embodiments relate to computer-implemented systems and processes that facilitate a prediction of occurrences of product-specific events during targeted temporal intervals using trained artificial intelligence processes. For example, an apparatus may generate an input dataset based on elements of first interaction data associated with an occurrence of a first event. Based on an application of a trained artificial intelligence process to the input dataset, the apparatus may generate an element of output data representative of a predicted likelihood of an occurrence of each of a plurality of second events during a target temporal interval associated with the first event. The apparatus may also transmit the elements of output data to a computing system, which may perform operations that are consistent with the elements of output data.

### CROSS-REFERENCE TO RELATED APPLICATION

This application claims the benefit of priority under 35 U.S.C. § 119(e) to prior U.S. Provisional Application No. 63/173,143, filed Apr. 9, 2021, the disclosure of which is incorporated by reference herein to its entirety.

### TECHNICAL FIELD

The disclosed embodiments generally relate to computer-implemented systems and processes that facilitate a prediction of occurrences of product-specific events during targeted temporal intervals using trained artificial intelligence processes.

### BACKGROUND

Today, financial institutions offer a variety of financial products or services to their customers, both through in-person branch banking and through various digital channels, and decisions related to the provisioning of a particular financial product or service to a customer are often informed by the customer's relationship with the financial institution and the customer's use, or misuse, of other financial products or services. For example, one or more computing systems of a financial institution, and based on an application for an auto loan from a customer, the financial institution may implement an origination process that determines a credit worthiness of the customer, approves the auto loan for the customer subject to certain initial terms and conditions, and disburses funds associated with the approved auto loan to the customer, who many finance a purchase of a vehicle using the disbursed funds.

### SUMMARY

In some examples, an apparatus includes a memory storing instructions, a communications interface, and at least one processor coupled to the memory and the communications interface. The at least one processor is configured to execute the instructions to generate an input dataset based on elements of first interaction data. The first interaction data is associated with an occurrence of a first event. The at least one processor is further configured to execute the instructions to, based on an application of a trained artificial intelligence process to the input dataset, generate an element of output data representative of a predicted likelihood of an occurrence of each of a plurality of second events during a target temporal interval. The target temporal interval is associated with the first event. The at least one processor is further configured to execute the instructions to transmit the elements of output data to a computing system via the communications interface, and the computing system is configured to perform operations that are consistent with the elements of output data.

In other examples, a computer-implemented method includes generating, using at least one processor, an input dataset based on elements of first interaction data. The first interaction data is associated with an occurrence of a first event. The computer-implemented method also includes, based on an application of a trained artificial intelligence process to the input dataset, generating, using the at least one processor, an element of output data representative of a predicted likelihood of an occurrence of each of a plurality of second events during a target temporal interval. The target temporal interval is associated with the first event. The computer-implemented method also includes transmitting, using the at least one processor, the elements of output data to a computing system, and the computing system being configured to perform operations that are consistent with the elements of output data.

Further, in some examples, a tangible, non-transitory computer-readable medium storing instructions that, when executed by at least one processor, cause the at least one processor to perform a method that includes generating an input dataset based on elements of first interaction data. The first interaction data is associated with an occurrence of a first event. The method also includes, based on an application of a trained artificial intelligence process to the input dataset, generating an element of output data representative of a predicted likelihood of an occurrence of each of a plurality of second events during a target temporal interval. The target temporal interval is associated with the first event. The method also includes transmitting the elements of output data to a computing system, and the computing system is configured to perform operations that are consistent with the elements of output data.

It is to be understood that both the foregoing general description and the following detailed description are exemplary and explanatory only and are not restrictive of the invention, as claimed. Further, the accompanying drawings, which are incorporated in and constitute a part of this specification, illustrate aspects of the present disclosure and together with the description, serve to explain principles of the disclosed exemplary embodiments, as set forth in the accompanying claims.

### BRIEF DESCRIPTION OF THE DRAWINGS

FIGS. 1A, 1B, and 1C are block diagrams illustrating portions of an exemplary computing environment, in accordance with some exemplary embodiments.

FIGS. 1D and 1E are diagrams of exemplary timelines for adaptively training a machine-learning or artificial intelligence process, in accordance with some exemplary embodiments.

FIG. 2 is a block diagram illustrating additional portions of the exemplary computing environment, in accordance with some exemplary embodiments.

FIG. 3 is a flowchart of an exemplary process for adaptively training a machine learning or artificial intelligence process, in accordance with some exemplary embodiments.

FIG. 4 is a flowchart of an exemplary process for predicting a likelihood of an occurrence of each of a set of target repossession events during a future, checkpoint-specific temporal interval based on an application of an adaptively trained machine-learning or artificial-intelligence process to an input dataset, in accordance with some exemplary embodiments.

FIG. 5 is a flowchart of an exemplary process 500 for selecting and applying a remediation process associated with a delinquent auto loan product, in accordance with some examples.

Like reference numbers and designations in the various drawings indicate like elements.

### DETAILED DESCRIPTION

Modern financial institutions offer a variety of financial products or services to their customers, both through in-person branch banking and through various digital channels, and decisions related to the provisioning of a particular financial product or service to a customer are often informed by the customer's relationship with the financial institution and the customer's use, or misuse, of other financial products or services. For example, based on an application for secured credit product by a customer, one or more computing systems of a financial institution may initiate, and execute, an origination process that determines a credit worthiness of the customer, approves the customer for the unsecured credit product subject to certain initial terms and conditions, and disburses funds associated with the now-approved, unsecured credit product to the customer in accordance with the initial terms and conditions.

By way of example, the unsecured credit product may include an auto loan product, and customer may elect to fund a purchase of a vehicle using the funds disbursed from the approved auto loan product. In some instances, the origination processes associated with the auto loan product, including the decision to approve the auto loan product and the determination of the initial terms and conditions, may be informed by, among other things, the customer's credit score at origination, a value of the vehicle and the loan-to-value ratio at origination, and the customer's prior relationship with the financial institution and with other financial products provisioned by the financial institution. Further, and by way of example, the initial terms and condition of the auto loan product may require that the customer submit a minimum payment (e.g., a portion of a principal amount and an amount of accrued interest) in accordance with a predetermined repayment schedule, e.g., a predetermined day of each month.

In some instances, the customer may submit the required monthly payment to the financial institution prior to each scheduled due date throughout the term of the auto loan product, and upon completion of the term (or upon an early payoff), the financial institution may discharge the auto loan product and release the customer of any further obligation. In other examples, the customer may fail to submit one of the required monthly payments to the financial institution in accordance with the corresponding repayment schedule (e.g., on or before a due date), and based on the failure to submit the required monthly payment, the auto loan may become “past due” as of the corresponding due date of the required monthly payment. As described herein, the failure to submit the required monthly payment associated with the auto loan by the corresponding due date may, for example, represent an occurrence of a “delinquency event” involving the auto loan product and the customer, and the delinquency event may remain pending, and the auto loan past due, until resolution by customer of the financial institution or by the financial institution.

The failure of the customer to submit the required monthly payment may result, for example, from carelessness or a lapse of memory on the part of the customer, and the customer may resolve the delinquency event by submitting the past-due monthly payment to the financial institution prior to the next scheduled due date, e.g., within a thirty-day past due interval of the initially missed due date. As the delinquency events associated with carelessness or lapse of memory are often resolved by the customer within the thirty-day past-due interval, the delinquency event may represent a low risk to the financial institution, and the financial institution may decline to intervene in the resolution of the delinquency event during this initial, thirty-day past-due interval. In other instances, the failure of the customer to submit the required monthly payment, and the associated delinquency event, may be indicative of financial distress on the part of the customer, and the underlying, or root, causes of the occurrence of the delinquency event may be indicative of a speed and an ease at which the delinquency event may be resolved by the customer and the financial institution, either unilaterally or through collection action.

For example, and upon missing second, successive one of the required monthly payments, the auto loan may be associated with a past-due period of thirty-one days (e.g., measured relative to the due date of the required monthly payment initially missed by the customer). Further, upon a determination that the initially missed payment is forty-five days past due, the financial institution may perform operations that generate, and provision to the customer, a notification indicating to the customer that the required monthly payment is forty-five days past due, and absent repayment (with interest and penalty), the financial institution may intervene and repossess the vehicle to mitigate any losses associated with the auto loan. If the auto loan remains delinquent and becomes associated with a past-due interval between sixty and seventy-five days (e.g., the customer did not resolve the delinquency event and submit the past-due payment(s) in response to the cure letter), the financial institution may intervene and may provide notice to the customer that the vehicle will be repossessed and sold to offset the financial institution's exposure to the auto loan within a five- to ten-day period, either on a voluntary or involuntary basis.

In some instances, and responsive to repossession of the vehicle, the customer may elect to maintain ownership and may provision payment to the financial institution that resolves the delinquency event, e.g., by submitting payment for the past-due balance, interest, and assessed fees. Upon receipt of the provisioned payment, the financial institution may elect to reinstate the auto loan (e.g., “reinstatement”), and the customer may continue to make the required monthly payments in accordance with the initial, or subsequently modified, terms and conditions of the auto loan. In other instances, the customer may decline to maintain ownership of the vehicle or may decline provision payment the that resolves the delinquency event, and the financial institution may maintain possession of the vehicle and may sell the vehicle to offset its exposure to the delinquent auto loan (e.g., “repossession without reinstatement”). Additionally, in some instances, the financial institution may be unable to locate the vehicle, and after the past-due interval associated with the delinquent auto loan exceeds 120 days, the financial institution may write off the auto loan product, e.g., as a “skip charge,” and cease any further recovery efforts.

Although these existing processes may enable to the financial institution to mitigate its exposure to past-due and delinquent auto loan products, many of these existing mitigation processes are initiated only when a corresponding auto loan is significantly delinquent (e.g., forty-five days past due), and rigid procession of each escalating step in these mitigation processes may be incapable of addressing the underlying causes of the past-due auto loan product and may be incapable of adapting to reflect the underlying causes. In some examples, described herein, a machine-learning or artificial-intelligence process may be adaptively trained to predict, for a delinquent auto loan product and a corresponding delinquency checkpoint, a likelihood of an occurrence of each of a set of target repossession events during a future, checkpoint-specific temporal interval. As described herein, the delinquent auto loan product may be held by a customer of the financial institution, and may be associated with a past-due interval measured relative to a due date of an initial missed payment (e.g., the initially missed due date described herein). Further, and as described herein, the delinquency checkpoints may include, among other things, a past-due interval of thirty-one days (e.g., two successive missed monthly payments), a past-due interval of forty-five days, and past-due interval of sixty-one days (e.g., three successive missed monthly payments), and the future, checkpoint-specific temporal interval may include “look-ahead window” of six months, five months, and four months associated with respective ones of the thirty-one-day delinquency checkpoint, forty-five-day delinquency checkpoint, and sixty-one-day delinquency checkpoint

As described herein, the machine-learning or artificial-intelligence process may include an ensemble or decision-tree process, such as a gradient-boosted decision-tree process (e.g., XGBoost process), and certain of the exemplary training and validation processes described herein may generate, and utilize, training datasets associated with a first prior temporal interval (e.g., a “training” interval), and using validation datasets associated with a second, and distinct, prior temporal interval (e.g., an out-of-time “validation” interval). In some examples, the training and validation data may include elements of data, e.g., feature values, characterizing delinquent auto loan products associated with a past-due interval of thirty-one days, forty-five days, and/or sixty-one days (e.g., the delinquency checkpoints described herein), and characterizing the customers that hold these delinquent auto loan products.

Through the implementation of the exemplary processes described herein, one or more computing systems of the financial institution (e.g., which may collectively establish a distributed computing cluster associated with the financial institution) may perform operations that train, adaptively and simultaneously, the machine-learning or artificial-intelligence process to predict the likelihood of the future occurrences of each of a set of target repossession events at each of the delinquency checkpoints described herein. Further, the trained machine-learning or artificial-intelligence process (e.g., the trained gradient-boosted, decision-tree process described herein) may further ingest product-specific input datasets associated with delinquent auto loan products characterized by corresponding ones of the delinquency checkpoints described herein. Based on the application of the trained gradient-boosted, decision-tree process to the loan-specific input datasets, the one or more FI computing systems may generate, for each of the delinquent auto loan products and at the corresponding ones of the delinquency checkpoints, loan-specific elements of output data indicative of a likelihood of an occurrence of each of a set of target repossession events during a future, checkpoint-specific temporal interval.

For example, the target repossession events may include, but are not limited to, a repossession event without reinstatement, a reinstatement event, a skip-charge event, or a non-occurrence of any event, and the elements of output data associated with each of the delinquent auto loan products and the corresponding one of the delinquency checkpoints may include a numerical value indicative of the predicated likelihood of each of the target repossession events, e.g., with zero indicating a minimum predicted likelihood, and with unity being indicative of a maximum predicted likelihood. Further, in some instances, the numerical values associated with the target repossession events may be scaled, such that for each of the delinquent auto loan products and the corresponding one of the delinquency checkpoints, the numerical values sum to unity, e.g., indicating an expected occurrence of one of the target repossession events.

Furthermore, and based on the application of the trained and validated gradient-boosted, decision-tree processes to input datasets characterizing customers of the financial institution associated with corresponding delinquency events, certain of these exemplary processes may enable the one or more computing systems of the financial institution to generate, at or before a predetermined time on a daily basis, and for each of the delinquent auto loan products and at the corresponding ones of the delinquency checkpoints, loan-specific elements of output data indicative of a likelihood of an occurrence of each of a set of target repossession events during a future, checkpoint-specific temporal interval (e.g., via the implementation of one or more of the parallelized, fault-tolerant distributed computing and analytical protocols described herein across clusters of graphical processing units (GPUs) and/or tensor processing units (TPUs)). These exemplary processes may, for example, be implemented by the one or more computing systems of the financial institution in addition to, or as an alternative to, other predictive processes that rely on rules-based scoring and coarse predictors, such as credit score, to guide the identification and implementation of a mediation process appropriate to a delinquent auto loan.

A. Exemplary Processes for Adaptively Training Gradient-Boosted, Decision Tree

Processes in a Distributed Computing Environment

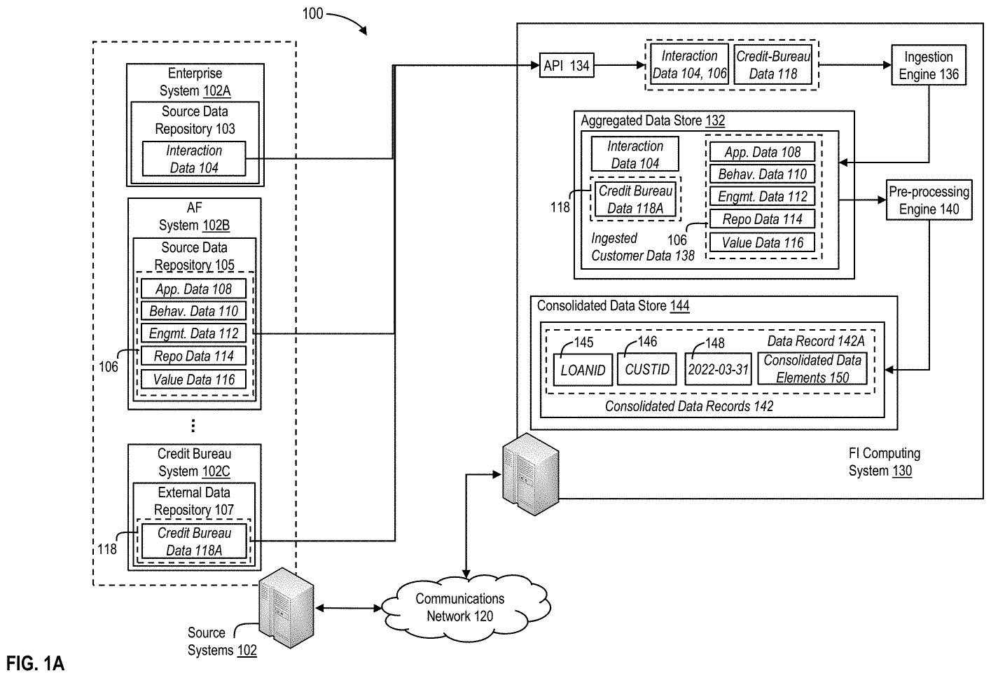

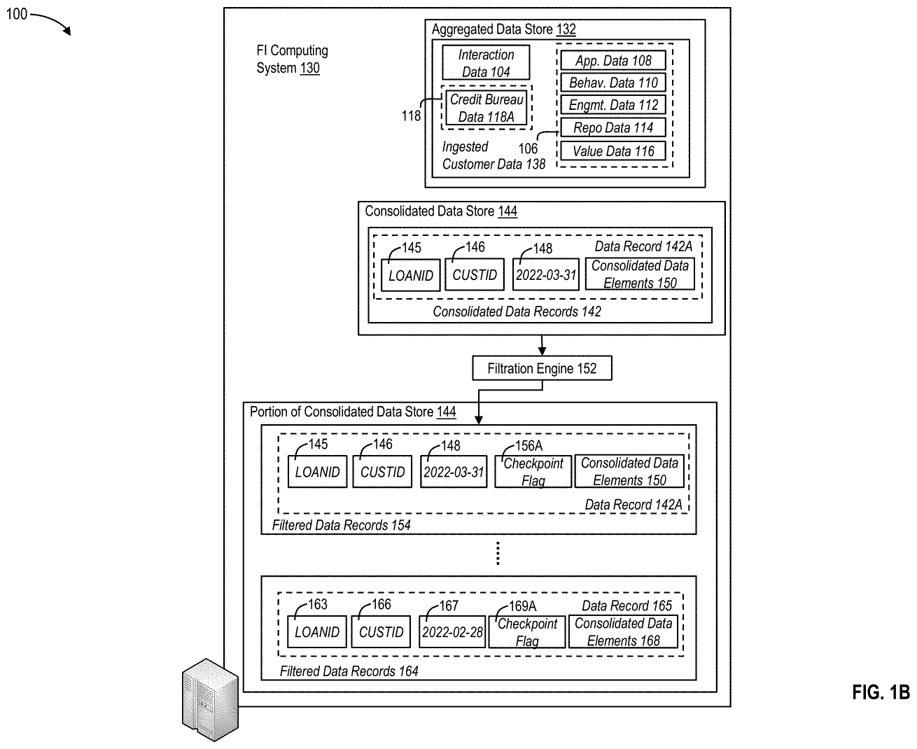

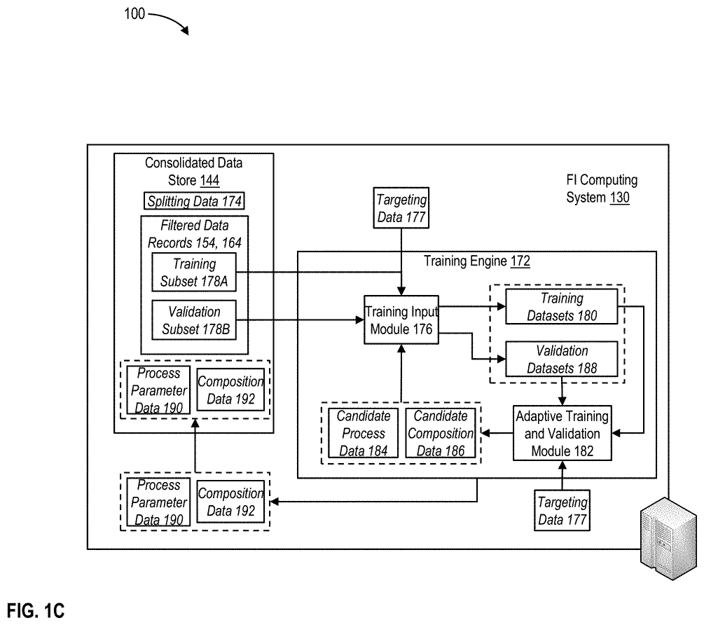

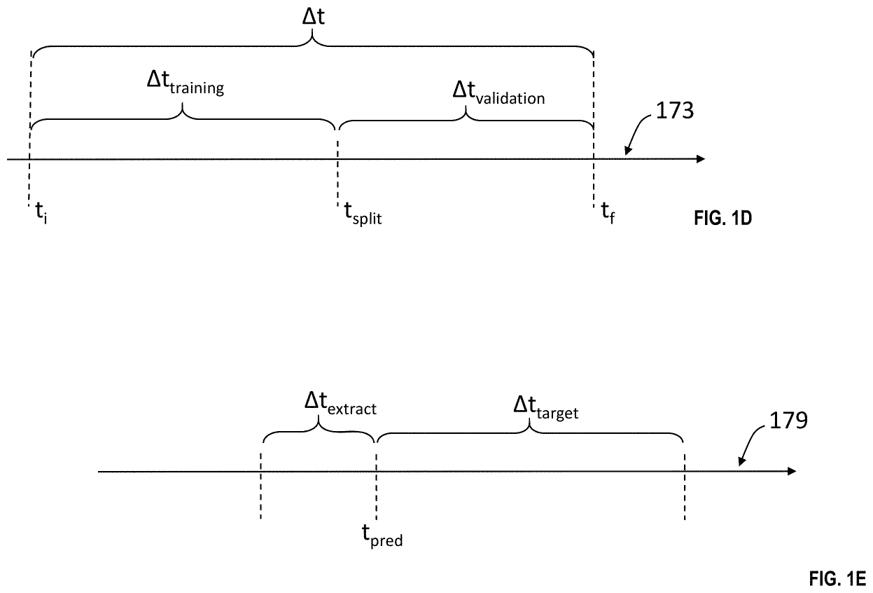

FIGS. 1A, 1B, and 1C illustrate components of an exemplary computing environment 100, in accordance with some exemplary embodiments. For example, as illustrated in FIG. 1A, environment 100 may include one or more source systems 102, such as, but not limited to, enterprise system 102A, auto finance (AF) system 102B, and credit bureau system 102C and one or more computing systems associated with, or operated by, a financial institution, such as a financial institution (FI) computing system 130. In some instances, each of source systems 102 (including enterprise system 102A, auto finance (AF) system 102B, and credit bureau system 102C) and FI computing system 130 may be interconnected through one or more communications networks, such as communications network 120. Examples of communications network 120 include, but are not limited to, a wireless local area network (LAN), e.g., a “Wi-Fi” network, a network utilizing radio-frequency (RF) communication protocols, a Near Field Communication (NFC) network, a wireless Metropolitan Area Network (MAN) connecting multiple wireless LANs, and a wide area network (WAN), e.g., the Internet.

In some examples, each of source systems 102 (including enterprise system 102A, auto finance (AF) system 102B, and credit bureau system 102C) and FI computing system 130 may represent a computing system that includes one or more servers and tangible, non-transitory memories storing executable code and application modules. Further, the one or more servers may each include one or more processors, which may be configured to execute portions of the stored code or application modules to perform operations consistent with the disclosed embodiments. For example, the one or more processors may include a central processing unit (CPU) capable of processing a single operation (e.g., a scalar operation) in a single clock cycle. Further, each of source systems 102 (including enterprise system 102A, auto finance (AF) system 102B, and credit bureau system 102C) and FI computing system 130 may also include a communications interface, such as one or more wireless transceivers, coupled to the one or more processors for accommodating wired or wireless internet communication with other computing systems and devices operating within environment 100.

Further, in some instances, source systems 102 (including enterprise system 102A, auto finance (AF) system 102B, and credit bureau system 102C) and FI computing system 130 may each be incorporated into a respective, discrete computing system. In additional, or alternate, instances, one or more of source systems 102 (including enterprise system 102A, auto finance (AF) system 102B, and credit bureau system 102C) and FI computing system 130 may correspond to a distributed computing system having a plurality of interconnected, computing components distributed across an appropriate computing network, such as communications network 120 of FIG. 1A. For example, FI computing system 130 may correspond to a distributed or cloud-based computing cluster associated with, and maintained by, the financial institution, although in other examples, FI computing system 130 may correspond to a publicly accessible, distributed or cloud-based computing cluster, such as a computing cluster maintained by Microsoft Azure™, Amazon Web Services™, Google Cloud™, or another third-party provider.

In some instances, FI computing system 130 may include a plurality of interconnected, distributed computing components, such as those described herein (not illustrated in FIG. 1A), which may be configured to implement one or more parallelized, fault-tolerant distributed computing and analytical processes (e.g., an Apache Spark™ distributed, cluster-computing framework, a Databricks™ analytical platform, etc.). Further, and in addition to the CPUs described herein, the distributed computing components of FI computing system 130 may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle. Through an implementation of the parallelized, fault-tolerant distributed computing and analytical protocols described herein, the distributed computing components of FI computing system 130 may perform any of the exemplary processes described herein, in accordance with a predetermined temporal schedule, to ingest elements of data associated with the customers of the financial institution, to preprocess the ingested data elements by filtering, aggregating, down-sampling, and/or consolidating certain portions of the ingested data elements, and to store the preprocessed data elements within an accessible data repository (e.g., within a portion of a distributed file system, such as a Hadoop distributed file system (HDFS)).

Further, and through an implementation of the parallelized, fault-tolerant distributed computing and analytical protocols described herein, the distributed components of FI computing system 130 may perform operations in parallel that not only train adaptively a machine learning or artificial intelligence process (e.g., the gradient-boosted, decision-tree process described herein) using corresponding training and validation datasets extracted from temporally distinct subsets of the preprocessed data elements, but also apply the adaptively trained machine learning or artificial intelligence process to loan-specific input datasets and generate, for one or more delinquent auto loan products and at the corresponding ones of the delinquency checkpoints, loan-specific elements of output data indicative of a likelihood of an occurrence of each of a set of target repossession events during a future, checkpoint-specific temporal interval. The implementation of the parallelized, fault-tolerant distributed computing and analytical protocols described herein across the one or more GPUs or TPUs included within the distributed components of FI computing system 130 may, in some instances, accelerate the training, and the post-training deployment, of the machine-learning and artificial-intelligence process when compared to a training and deployment of the machine-learning and artificial-intelligence process across comparable clusters of CPUs capable of processing a single operation per clock cycle.

Referring back to FIG. 1A, each of source systems 102 may maintain, within corresponding tangible, non-transitory memories, a data repository that includes confidential data associated with auto loan products originated by the financial institution and customers of the financial institution that hold these auto loan products. For example, enterprise system 102A may be associated with, or operated by, the financial institution, and may maintain, within the corresponding one or more tangible, non-transitory memories, a source data repository 103 that includes one or more elements of interaction data 104. In some instances, interaction data 104 may include data that identifies or characterizes one or more customers of the financial institution and interactions between these customers and the financial institution, and examples of the confidential data include, but are not limited to, customer profile data, account data, and transaction data.

In some instances, the customer profile data may include a plurality of data records associated with, and characterizing, corresponding ones of the customers of the financial institution. By way of example, and for a particular customer of the financial institution, the data records may include, but are not limited to, one or more unique customer identifiers (e.g., an alphanumeric character string, such as a login credential, a customer name, etc.), residence data (e.g., a street address, etc.), other elements of contact data (e.g., a mobile number, an email address, etc.), values of demographic parameters that characterize the particular customer (e.g., ages, occupations, marital status, etc.), and other data characterizing the relationship between the particular customer and the financial institution.

The account data may also include a plurality of data records that identify and characterize one or more financial products or instruments issued by the financial institution to corresponding ones of the customers. For example, the data records may include, for each of the financial products issued to corresponding ones of the customers, one or more identifiers of the issued financial product or instrument (e.g., an account number, expiration data, card-security-code, etc.), one or more unique customer identifiers (e.g., an alphanumeric character string, such as a login credential, a customer name, etc.), information identifying a product type that characterizes the issued financial product or instrument, and additional information characterizing a balance or current status of the financial product or instrument (e.g., payment due dates or amounts, delinquent accounts statuses, etc.). Examples of the issued financial products or instruments, and their corresponding product types, may include, but are not limited to, a demand deposit account (e.g., a savings account, a checking account), a term deposit account (e.g., a certificate of deposit), an investment or brokerage account, a retirement accounts, and/or a credit product, such as a credit-card account, a home mortgage, an auto loan product, an unsecured personal loan product, a secured or unsecured line-of-credit, and/or an overdraft protection (ODP) product.

The transaction data may also include data records that identify and characterize transactions initiated by, and involving, customers of the financial institution. The transactions may include purchase transactions initiated by a customer of the financial institution and involve a corresponding counterparty (e.g., a merchant, retailer, or other business that offers products or services for sale) and may be funded by a corresponding one of the financial products or instruments issued by the financial institution and held by that customer. In other example, the transaction may also include other types of transactions initiated by, or involving, the customers of the financial institution, such as, but not limited to, bill-payment transactions, electronic funds transfers, currency conversions, purchases or sales of securities, derivatives, or other tradeable instruments, electronic funds transfer (EFT) transactions, or peer-to-peer (P2P) transfers or transactions.

Further, as illustrated in FIG. 1A, AF system 102B may also be associated with, or operated by, the financial institution, and may perform any of the exemplary processes described herein to originate auto loan products involving corresponding customers, to manage repayments associated with each of the originated auto loan products, and in some examples, to initiate repossession processes that mitigate an exposure to one or more delinquent auto loan products associated with past-due balances. For example, AF system 102B may maintain, the corresponding one or more tangible, non-transitory memories, a source data repository 105 that includes one or more elements of interaction data 106, which includes, among other things, application data 108 characterizing one or more originated auto loan products, behavioral data 110 characterizing a status and behavior of each of the originated auto loan products, engagement data 112 characterizing interactions between the financial institution and the customers that hold each of the originated auto loan products, and repossession data 114 identifying and characterizing one or more repossession processes applied to the originated auto loan products (e.g., the target repossession events described herein), and value data 116.

For example, application data 108 may include, for each of the originated auto loan products, a unique identifier of the auto loan (e.g., a tokenized account number, etc.), a unique identifier of the customer that holds the auto loan (e.g., an alphanumeric identifier or login credential, a customer name, etc.), and data characterizing the origination of the auto loan (e.g., a loan-to-value (LTV) ratio of the auto loan at origination, a payment to income (PTI) ratio of the customer at initiation, an origination amount, a credit score of the customer at initiation, a vehicle age, etc.). Behavioral data 110 may also include, for each of the originated auto loan products, the unique identifier of the auto loan product, data characterizing a current balance (principal, interest, etc.) of the auto loan product, delinquency data associated with the auto loan (e.g., a current delinquency status of the auto loan product, a past-due interval and a past-due amount associated with the delinquent auto loan), along with additional information characterizing a historical behavior of the auto loan (e.g., a history of declining balances, historical delinquencies, recent delinquency events, etc.).

Further, in some examples engagement data 112 may identify and characterize interactions between the financial institution and delinquent ones of the originated auto loan products. For instance, and for each of the delinquent auto loan products, engagement data 112 may include the unique identifier of the auto loan product and data characterizing the loan-specific interactions, such as, but not limited to, times and dates of telephone calls made by representatives of the financial institution to customers that hold the delinquent auto loan products, times and dates of promises for payment made by these customers in response to the interactions, and information characterizing whether these promises are kept. Repossession data 114 may include, for one or more of the delinquent auto loan products, the unique identifier of the auto loan product and data characterizing the one or more repossession processes applied to the delinquent auto loan products, e.g., a date of repossession without reinstatement, a date of reinstatement, or a date of write-off as a skip-charge. Additionally, as illustrated in FIG. 1A, interaction data 106 may also include value data 116, which identifies, for each of the auto loan products, a current monetary value of an underlying vehicle, e.g., Blue Book™ value.

Credit bureau system 102C may be associated with, or operated by, a reporting entity, such as a credit bureau, and may maintain, within the corresponding one or more tangible, non-transitory memories, a source data repository 107 that includes one or more elements of credit bureau data 118A. In some instances, credit bureau data 118A may include data records for a customer of the financial institution, which may include a unique identifier of the customer (e.g., an alphanumeric identifier or login credential, a customer name, etc.), information identifying one or more financial products or instruments currently or previously held by the customer, information identifying a history of payments associated with these financial products or instruments, information identifying negative events associated with the customer (e.g., missed payments, collections, repossessions, etc.), and/or information identifying one or more credit inquiries involving the customer (e.g., inquiries by the financial institution, other financial institutions or business entities, etc.). The disclosed embodiments are, however, not limited to these exemplary elements of credit bureau data 118A, and in other instances, credit bureau data 118A may include any additional or alternate elements of data associated with the customer and generated by the judicial, regulatory, governmental, or regulatory entities described herein, such as additional, or alternate, elements of credit bureau data.

In some instances, FI computing system 130 may perform operations that establish and maintain one or more centralized data repositories within a corresponding ones of the tangible, non-transitory memories. For example, as illustrated in FIG. 1A, FI computing system 130 may establish an aggregated data store 132, which maintains, among other things, elements of the interaction data and credit bureau data, which may be ingested by FI computing system 130 (e.g., from one or more of source systems 102) using any of the exemplary processes described herein. Aggregated data store 132 may, for instance, correspond to a data lake, a data warehouse, or another centralized repository established and maintained, respectively, by the distributed components of FI computing system 130, e.g., through a Hadoop™ distributed file system (HDFS).

For example, FI computing system 130 may execute one or more application programs, elements of code, or code modules that, in conjunction with the corresponding communications interface, establish a secure, programmatic channel of communication with each of source systems 102, including enterprise system 102A, AF system 102B, and credit bureau system 102C, across network 120, and may perform operations that access and obtain all, or a selected portion, of the elements of data maintained by corresponding ones of source systems 102. As illustrated in FIG. 1A, enterprise system 102A may perform operations that obtain all, or a selected portion, of interaction data 104 from source data repository 103, and transmit the obtained portions of interaction data 104 across network 120 to FI computing system 130. Further, AF system 102B may also perform operations that obtain all, or a selected portion, of interaction data 106 from source data repository 105, and transmit the obtained portions of interaction data 106 across network 120 to FI computing system 130. Additionally, in some instances, credit bureau system 102C may also perform operations that obtain all, or a selected portion, of interaction data 118 (including credit bureau data 118A) from source data repository 107 and transmit the obtained portions of interaction data 118 (including credit bureau data 118A) across network 120 to FI computing system 130.

In some instances, and prior to transmission across network 120 to FI computing system 130, enterprise system 102A, AF system 102B, and credit bureau system 102C may encrypt respective portions of interaction data 104, interaction data 106, and interaction data 118 (including credit bureau data 118A) using a corresponding encryption key, such as, but not limited to, a corresponding public cryptographic key associated with FI computing system 130. Further, although not illustrated in FIG. 1A, each of source systems 102 may perform any of the exemplary processes described herein to obtain, encrypt, and transmit additional, or alternate, portions of the locally maintained customer profile, account, transaction, application, behavioral, engagement, repossession, value, and credit bureau data maintained across network 120 to FI computing system 130.

A programmatic interface established and maintained by FI computing system 130, such as application programming interface (API) 134, may receive the portions of interaction data 104 from enterprise system 102A, interaction data 106 from AF system 102B, and interaction data 118 (including credit bureau data 118A) from credit bureau system 102C. As illustrated in FIG. 1A, API 134 may route the portions of interaction data 104 (including the data records of customer profile data, account data, and transaction data described herein), interaction data 106 (including application data 108, behavioral data 110, engagement data 112, repossession data 114, and value data 116), and interaction data 118 (including credit bureau data 118A) to a data ingestion engine 136 executed by the one or more processors of FI computing system 130. As described herein, the portions of interaction data 104, interaction data 106, and interaction data 118 may be encrypted, and executed data ingestion engine 136 may perform operations that decrypt each of the encrypted portions of interaction data 104, interaction data 106, and interaction data 118 using a corresponding decryption key, e.g., a private cryptographic key associated with FI computing system 130.

Executed data ingestion engine 136 may also perform operations that store the portions of interaction data 104 (including the data records of customer profile data, account data, and transaction data described herein), interaction data 106 (including application data 108, behavioral data 110, engagement data 112, repossession data 114, and value data 116), and interaction data 118 (including credit bureau data 118A) within aggregated data store 132, e.g., as ingested customer data 138. As illustrated in FIG. 1A, a pre-processing engine 140 executed by the one or more processors of FI computing system 130 may access the elements of ingested customer data 138, and perform any of the exemplary data-processing operations described herein to preprocess the accessed elements of ingested customer data 138 and to generate consolidated data records 142 that characterize corresponding ones of the originated auto loan products, the customers that hold the originated, and their interactions between the financial institution, the originated auto loan products, and the customers during a temporal interval associated with the ingestion of interaction data 104, interaction data 106, and credit bureau data 118A by executed data ingestion engine 136.

By way of example, executed pre-processing engine 140 may access the data records of interaction data 104, interaction data 106, and/or credit bureau data 118A (e.g., as maintained within ingested customer data 138). As described herein, each of the accessed data records may include an identifier of corresponding customer of the financial institution, such as a customer name or an alphanumeric character string, and executed pre-processing engine 140 may perform operations that map each of the accessed data records to a customer identifier assigned to the corresponding customer by FI computing system 130. By way of example, FI computing system 130 may assign a unique, alphanumeric customer identifier to each customer, and executed pre-processing engine 140 may perform operations that parse the accessed data records, identify each of the parsed data records that identifies the corresponding customer using a customer name, and replace that customer name with the corresponding alphanumeric customer identifier.

Executed pre-processing engine 140 may also perform operations that assign a temporal identifier to each of the accessed data records, and that augment each of the accessed data records to include the newly assigned temporal identifier. In some instances, the temporal identifier may associate each of the accessed data records with a corresponding temporal interval, which may be indicative or reflect a regularity or a frequency at which FI computing system 130 ingests the elements of interaction data 104, interaction data 106, and credit bureau data 118A. For example, executed data ingestion engine 136 may receive elements of confidential customer data from corresponding ones of source systems 102 on a daily basis, a weekly basis, or a monthly basis, and, in particular, may receive and store the elements of interaction data 104, interaction data 106, and credit bureau data 118A from corresponding ones of source systems 102 on Mar. 1, 2022. Executed pre-processing engine 140 may generate a temporal identifier associated with the regular, monthly ingestion of interaction data 104, interaction data 106, and credit bureau data 118A on Mar. 31, 2022 (e.g., “2022 Mar. 31”), and may augment the accessed data records of interaction data 104, interaction data 106, and/or credit bureau data 118A to include the generated temporal identifier. The disclosed embodiments are, however, not limited to temporal identifiers reflective of a monthly ingestion of interaction data 104, interaction data 106, and credit bureau data 118A by FI computing system 130, and in other instances, executed pre-processing engine 140 may augment the accessed data records to include temporal identifiers reflective of any additional, or alternative, temporal interval during which FI computing system 130 ingests the elements of interaction data 104, interaction data 106, and credit bureau data 118A.

In some instances, executed pre-processing engine 140 may perform further operations that, for a particular auto loan product held by a corresponding customer during the temporal interval (e.g., represented by triplet of the loan product, customer, and temporal identifiers described herein), obtain one or more data records of interaction data 104, 106, and 118 that are associated with the particular auto loan product, the corresponding customers, and the temporal interval, and the include or references all, or a portion of the loan product, customer, and temporal identifiers. Executed pre-processing engine 140 may perform operations that consolidate the one or more obtained data records and generate a corresponding one of consolidated data records 142 that includes the customer identifier and temporal identifier, and that is associated with, and characterizes, the particular auto loan product and the corresponding customer across the temporal interval. By way of example, executed pre-processing engine 140 may consolidate the obtained data records through an invocation of an appropriate Java-based SQL “join” command (e.g., an appropriate “inner” or “outer” join command, etc.).

Further, executed pre-processing engine 140 may perform any of the exemplary processes described herein to generate another one of consolidated data records 142 for each additional, or alternate, one of the originated auto loan products held by customers of the financial institution during the temporal interval (e.g., as represented by a corresponding loan product, customer, and temporal identifier). In some instances, executed pre-processing engine 140 may perform operations that store each of consolidated data records 142 within one or more tangible, non-transitory memories of FI computing system 130, such as consolidated data store 144. Consolidated data store 144 may, for example, correspond to a data lake, a data warehouse, or another centralized repository established and maintained, respectively, by the distributed components of FI computing system 130, e.g., through a Hadoop™ distributed file system (HDFS).

In some instances, and as described herein, consolidated data records 142 may include a plurality of discrete data records, each of these discrete data records may be associated with, and may maintain data characterizing, an originated auto loan held by a corresponding one of the customers of the financial institution during the corresponding temporal interval (e.g., a month-long interval extending from Mar. 1, 2022, to Mar. 31, 2022). By way of example, and for a particular one of the auto loan products held by a particular customer of the financial institution, discrete data record 142A of consolidated data records 142 may include a loan identifier 145 of the particular auto loan (e.g., an alphanumeric character string “LOAN ID”), a customer identifier 146 of the particular customer (e.g., an alphanumeric character string “CUSTID”), a temporal identifier 148 of a corresponding temporal interval (e.g., a numerical string “2022 Mar. 31”), and consolidated data elements 150 of consolidated data that identify and characterize the particular auto loan product, the particular customer during the corresponding temporal interval. For instance, consolidated data elements 150 may include, among other things, one or more of the data records of interaction data 104 (including the data records of customer profile data, account data, and transaction data described herein), interaction data 106 (including application data 108, behavioral data 110, engagement data 112, repossession data 114, and value data 116), and interaction data 118 (including credit bureau data 118A) associated with the particular auto loan product and the particular customer, and ingested by FI computing system 130 on Mar. 1, 2022.

Referring to FIG. 1B, a filtration engine 152 executed by the one or more processors of FI computing system 130 may access each of the data records of consolidated data records 142 maintained within consolidated data store 144 (e.g., data record 142A, as described herein), and perform operations that filter the accessed data records of consolidated data records 142 in accordance with one or more filtration or exclusion criteria. Executed filtration engine 152 may, for example, identify subsets of the data records of consolidated data records 142 that characterize, respectively, delinquent auto loan products associated with past due balances and corresponding past-due intervals, and auto loan products without past-due balances. In some examples, executed filtration engine 152 may deem the subset of the data records of consolidated data records 142 that characterize the auto loan products without past-due balances unsuitable for training and validating the machine-learning or artificial intelligence processes described herein, and may exclude the subset of data records that characterize the auto loan products without past-due balances from further processing.

Executed filtration engine 152 may also perform operations that access the data records that characterize the delinquent auto loan products, and identify a portion of the accessed data records that characterize delinquent auto loan products having a past-due interval equivalent to one of the delinquency checkpoints described herein, e.g., a past-due interval of thirty-one days, forty-five days, or sixty-one days. In some instances, executed filtration engine 152 may determine the identified portion of the accessed data records (e.g., characterizing delinquent auto loan products having past-due intervals equivalent to thirty-one days, forty-five days, or sixty-one days), and as such, may determine that identified portion of the accessed data records is suitable for training and validating the machine-learning or artificial intelligence processes described herein. Executed filtration engine 152 may perform operations that store the identified portion of the accessed data records within a corresponding portion of consolidated data store 144, e.g., as filtered data records 154.

For example, as illustrated in FIG. 1B, executed filtration engine 152 may access discrete data record 142A of consolidated records 142, which includes loan identifier 145 of the particular auto loan (e.g., an alphanumeric character string “LOANID”), customer identifier 146 of the particular customer (e.g., an alphanumeric character string “CUSTID”), temporal identifier 148 of the corresponding temporal interval (e.g., a numerical string “2022 Mar. 31”), and consolidated data elements 150. In some instances, executed filtration engine 152 may perform operations that parse consolidated data elements 150 and obtain information (described herein) that confirms the particular loan is delinquent, is associated with a past-due balance of $1,750, and a past-due interval of thirty-one days. Executed filtration engine 152 may establish that the past-due interval of the particular delinquent auto loan characterized by data record 142A is equivalent to the thirty-one-day delinquency checkpoint described herein, may determine that data record 142A is suitable for training and validating the machine-learning or artificial intelligence processes described herein. Executed filtration engine 152 may perform operations that store data record 142A within an additional portion of consolidated data store 144, e.g., as one of filtered data records 154. Further, as illustrated in FIG. 1A, executed filtration engine 152 may perform operations that augment data record 142A within filtered data records 154 to include data, such as checkpoint flag 156A, confirming that the particular delinquent auto loan is associated with the thirty-one-day delinquency checkpoint described herein.

Executed filtration engine 152 may access each of the additional data records of consolidated data records 142, and may perform any of the exemplary processes described herein to establish a consistency, or an inconsistency, between each of the additional data records and the filtration or exclusion criteria described herein. Based on the established consistency with all, or a selected subset, or these filtration criteria, executed filtration engine 152 may perform operations that store corresponding ones of the additional data records within filtered data records 154, e.g., in conjunction with a corresponding checkpoint flag confirming that the corresponding ones of the additional data records characterize a delinquent auto loan associated with a past-due interval consistent with one of the exemplary delinquency checkpoints, as described herein. Further, as illustrated in FIG. 1B consolidated data store 144 may maintain each of filtered data records 154 in conjunction with additional filtered data records 164. In some instances, executed pre-processing engine 140 and executed filtration engine 152 may perform any of the exemplary processes described herein, either individually or collectively, to generate each of the additional filtered data records 164 based on elements of interaction and credit bureau data ingested from source systems 102 during the corresponding prior temporal intervals.

In some instances, each of additional filtered data records 164 may include a plurality of discrete data records that are associated with and characterize an originate auto loan held by one of the customers of the financial institution during a corresponding one of the prior temporal intervals. For example, additional filtered data records 164 may include one or more discrete data records, such as discrete data record 165, associated with a prior temporal interval extending from Feb. 1, 2022, to Feb. 28, 2022. For a particular auto loan held by a particular customer, discrete data record 165 may include a loan identifier 163 of the particular loan (e.g., an alphanumeric character string “LOAN ID”), a customer identifier 166 of the particular customer (e.g., an alphanumeric character string “CUSTID”), a temporal identifier 167 of the prior temporal interval (e.g., a numerical string “2022 Feb. 28”), and consolidated data elements 168 of that characterize the particular auto loan product and the particular customer during the prior temporal interval extending from Feb. 1, 2022, to Feb. 28, 2022 (e.g., as consolidated from the data records ingested by FI computing system 130 on Feb. 28, 2022). As illustrated in FIG. 1B, discrete data record 165 may also include a checkpoint flag 169A, which confirms that the particular auto loan corresponds to a delinquent auto loan product having a past-due interval corresponding to one of the thirty-one-day, forty-five-day, or sixty-one day delinquency checkpoints described herein.

The disclosed embodiments are, however, not limited to the exemplary consolidated or filtered data records described herein, or to the exemplary temporal intervals described herein. In other examples, FI computing system 130 may generate, and the consolidated data store 144 may maintain, any additional or alternate number of discrete sets of filtered data records, having any additional or alternate composition, that would be appropriate to the elements of interaction or credit bureau data ingested by FI computing system 130 at the predetermined intervals described herein. Further, in some examples, FI computing system 130 may ingest elements of interaction or credit bureau data from source systems 102 at any additional, or alternate, fixed or variable temporal interval that would be appropriate to the ingested data.

In some instances, FI computing system 130 may perform any of the exemplary operations described herein to adaptively train, using training datasets associated with a first prior temporal interval (e.g., a “training” interval), and using validation datasets associated with a second, and distinct, prior temporal interval (e.g., an out-of-time “validation” interval, a machine-learning or artificial-intelligence process to predict, for a delinquent auto loan product associated with a corresponding delinquency checkpoint, a likelihood of an occurrence of each of a set of target repossession events during a future, checkpoint-specific temporal interval. As described herein, the delinquent auto loan product may be held by a customer of the financial institution, and may be associated with a past-due interval measured relative to a due date of an initial missed payment (e.g., the initially missed due date described herein). Further, and as described herein, the delinquency checkpoints may include, among other things, a past-due interval of thirty-one days (e.g., two successive missed monthly payments), a past-due interval of forty-five days, and past-due interval of sixty-one days (e.g., three successive missed monthly payments), and the future, checkpoint-specific temporal interval may include a “look-ahead window” of six months, five months, and four months associated with respective ones of the thirty-one-day delinquency checkpoint, forty-five-day delinquency checkpoint, and sixty-one-day delinquency checkpoint

As described herein, the machine-learning or artificial-intelligence process may include an ensemble or decision-tree process, such as a gradient-boosted decision-tree process (e.g., XGBoost process), and the training and validation datasets may include, but are not limited to, values of adaptively selected features obtained, extracted, or derived from the filtered data records maintained within consolidated data store 144, e.g., from data elements maintained within the discrete data records of filtered data records 154 or the additional filtered data records 164. In some examples, described herein, the training and validation datasets may include elements of data, e.g., feature values, characterizing delinquent auto loan products associated with a past-due interval of thirty-one days, forty-five days, and/or sixty-one days (e.g., the delinquency checkpoints described herein) and characterizing the customers that hold these delinquent auto loan products.

Further, and by way of example, the distributed computing components of FI computing system 130 (e.g., that include one or more GPUs or TPUs configured to operate as a discrete computing cluster) may perform any of the exemplary processes described herein to adaptively train the machine learning or artificial intelligence process (e.g., the gradient-boosted, decision-tree process), adaptively and simultaneously, to predict the likelihood of the future occurrences of each of a set of target repossession events across each of the delinquency checkpoints described herein in parallel through an implementation of one or more parallelized, fault-tolerant distributed computing and analytical processes. Based on an outcome of these adaptive training processes, FI computing system 130 may generate process coefficients, parameters, thresholds, and other process data that collectively specify the trained machine learning or artificial intelligence process, and may store the generated process coefficients, parameters, thresholds, and process data within a portion of the one or more tangible, non-transitory memories, e.g., within consolidated data store 144.

Referring to FIG. 1C, a training engine 172 executed by the one or more processors of FI computing system 130 may access the filtered data records maintained within consolidated data store 144, such as, but not limited to, filtered data records 154 or additional filtered data records 164. As described herein, each of the filtered data records, such as discrete data record 142A of filtered data records 154 or discrete data record 165 of additional filtered data records 164, may include a loan identifier associated with a delinquent auto loan (e.g., loan identifiers 145 and 163 of FIG. 1B), a customer identifier of a corresponding one of the customers that holds the delinquent auto loan product, (e.g., customer identifiers 146 and 166 of FIG. 1B), a temporal identifier that associates the filtered data record with a corresponding temporal interval (e.g., temporal identifiers 148 and 167 of FIG. 1B), and a checkpoint flag that confirms a past-due interval of the delinquent auto loan is equivalent to one of the exemplary delinquency checkpoints described herein (e.g., checkpoint flags 156A and 166A of FIG. 1B). Further, as described herein, each of the filtered data records may include consolidated elements of ingested interaction and credit bureau data that characterize the delinquent auto loan product and corresponding one of the customers during the corresponding temporal interval (e.g., consolidated data elements 150 and 168 of FIG. 1B).

In some instances, executed training engine 172 may parse the filtered data records, and based on corresponding ones of the temporal identifiers, determine that the consolidated elements of interaction and credit bureau data characterize the corresponding delinquent auto loan product and corresponding customers across a range of prior temporal intervals. Further, executed training engine 172 may also perform operations that decompose the determined range of prior temporal intervals into a corresponding first subset of the prior temporal intervals (e.g., the “training” interval described herein) and into a corresponding second, subsequent, and disjoint subset of the prior temporal intervals (e.g., the “validation” interval described herein). For example, as illustrated in FIG. 1D, the range of prior temporal intervals (e.g., shown generally as Δt along timeline 173 of FIG. 1D) may be bounded by, and established by, temporal boundaries tᵢ and t_{f}. Further, the decomposed first subset of the prior temporal intervals (e.g., shown generally as training interval Δt_{training} along timeline 173 of FIG. 1D) may be bounded by temporal boundary tᵢ and a corresponding splitting point twit along timeline 173, and the decomposed second subset of the prior temporal intervals (e.g., shown generally as validation interval Δt_{validation} along timeline 173 of FIG. 1D) may be bounded by splitting point tₛₚₗᵢₜ and temporal boundary t_{f}.

Referring back to FIG. 1C, executed training engine 172 may generate elements of splitting data 174 that identify and characterize the determined temporal boundaries (e.g., temporal boundaries tᵢ and t_{f}) and the range of prior temporal intervals established by the determined temporal boundaries The elements of splitting data 174 may also identify and characterize the splitting point (e.g., the splitting point tₛₚₗᵢₜ described herein), the first subset of the prior temporal intervals (e.g., the training interval Δt_{training} described herein), and the second, and subsequent subset of the prior temporal intervals (e.g., the validation interval Δt_{validation} described herein). As illustrated in FIG. 1C, executed training engine 172 may store the elements of splitting data 174 within the one or more tangible, non-transitory memories of FI computing system 130, e.g., within consolidated data store 144.

In some instances, each of the prior temporal intervals may correspond to a one-month interval, and executed training engine 172 may perform operations that establish adaptively the splitting point between the corresponding temporal boundaries such that a predetermined first percentage of the consolidated data records are associated with temporal intervals (e.g., as specified by corresponding ones of the temporal identifiers) disposed within the training interval, and such that a predetermined second percentage of the consolidated data records are associated with temporal intervals (e.g., as specified by corresponding ones of the temporal identifiers) disposed within the validation interval. By way of example, executed training engine 172 may compute one or both of the first and second predetermined percentages, and establish the splitting point, based on the range of prior temporal intervals, a quantity or quality of the consolidated data records maintained within consolidated data store 144, or a magnitude of the temporal intervals (e.g., one-month intervals, two-week intervals, one-week intervals, one-day intervals, etc.).

In some examples, a training input module 176 of executed training engine 172 may perform operations that access the filtered data records maintained within consolidated data store 144. As described herein, each of the accessed data records (e.g., the discrete data records within filtered data records 154 or additional filtered data records 164) may identify and characterize a delinquent auto loan product (e.g., identified by a corresponding loan identifier) and a customer of the financial institution that holds the delinquent auto loan (e.g., identified by a corresponding customer identifier) during a temporal interval (e.g., associated with a corresponding temporal identifier). In some instances, and based on portions of splitting data 174, executed training input module 176 may perform operations that parse the filtered data records and determine: (i) a first subset 178A of these consolidated data records are associated with the training interval Δt_{training} and may be appropriate to training adaptively the gradient-boosted decision process during the training interval; and a (ii) second subset 178B of these consolidated data records are associated with the validation interval Δt_{validation} and may be appropriate to validating the adaptively trained gradient-boosted decision process during the validation interval.

Prior to partitioning the filtered data records maintained within consolidated data store 144 into corresponding ones of first subset 178A and second subset 178B, executed training input module 176 may perform operations that augment each of the filtered data records (e.g., filtered data records 154 and 164, etc.) to include additional information characterizing a ground truth associated with the corresponding customer and temporal interval (as established by the corresponding pair of customer and temporal identifiers). For example, as illustrated in FIG. 1C, executed training input module 176 may perform operations that obtain one or more elements of targeting data 177, which identify each of the delinquency checkpoints described herein (e.g., a past-due interval of thirty-one days, forty-five days, or sixty-one days), the future, checkpoint-specific temporal intervals associated with corresponding ones of the delinquency checkpoints (e.g., “look-ahead windows” of six months, five months, and four months associated with respective ones of the thirty-one-day delinquency checkpoint, forty-five-day delinquency checkpoint, and sixty-one-day delinquency checkpoint), and each of the target repossession events described herein (e.g., a repossession event without reinstatement, a reinstatement event, a skip-charge event, or a non-occurrence of any event).

Further, for a particular one of the filtered data records, such as discrete data record 142A of filtered data records 154, executed training input module 176 may obtain loan identifier 145 (e.g., “LOAN ID”), which identifies the corresponding delinquent auto loan product, customer identifier 146 (e.g., “CUSTID”), which identifies the corresponding customer that holds the delinquent auto loan product, temporal identifier 148, which indicates data record 142A is associated with an ingestion date of Mar. 1, 2022, and checkpoint flag 156A, which confirms that the particular delinquent auto loan product is associated with the thirty-one-day delinquency checkpoint. As described herein, consolidated data elements 150 of discrete data record 142A may include consolidated elements of repossession data 114, which identifies whether one or more repossession processes (e.g., the target repossession events described herein) were applied to the corresponding delinquent auto loan during the future, checkpoint-specific temporal interval. Based on the consolidated elements of repossession data 114 and targeting data 177, executed training input module 176 may perform operations that modify data record 142A by appending an element of ground-truth data indicative of the occurrence or non-occurrence of a corresponding one of the target repossession events to data record 142A. Executed training input module 176 may also perform any of the exemplary processes described herein to generate and append an appropriate element of ground-truth data to each additional, or alternate, one of the sequentially ordered data records within each of the loan-specific sets of filtered data records maintained within consolidated data store 144.

Executed training input module 176 may also perform operations that partition the loan-specific sets of sequentially ordered data records into subsets suitable for training adaptively the machine-learning or artificial-intelligence process (e.g., which may be maintained in first subset 178A of filtered data records within consolidated data store 144) and for validating the adaptively trained, gradient-boosted, decision-tree process (e.g., which may be maintained in second subset 178B of filtered data records within consolidated data store 144). By way of example, executed training input module 176 may access splitting data 174, and establish the temporal boundaries for the training interval Δt_{training} (e.g., temporal boundary tᵢ and splitting point tₛₚₗᵢₜ) and the validation interval Δt_{validation} (e.g., splitting point tₛₚₗᵢₜ and temporal boundary t_{f}). Further, executed training input module 176 may also parse each of the sequentially ordered data records of the loan-specific sets, access the corresponding temporal identifier, and determine the temporal interval associated with the each of sequentially ordered data records.

If, for example, executed training input module 176 were to determine that the temporal interval associated with a corresponding one of the sequentially ordered data records is disposed within the temporal boundaries for the training interval Δt_{training}, executed training input module 176 may determine that the corresponding data record may be suitable for training, and may perform operations that include the corresponding data record within a portion of the first subset 178A (e.g., that store the corresponding data record within a portion of consolidated data store 144 associated with first subset 178A). Alternatively, if executed training input module 176 were to determine that the temporal interval associated with a corresponding one of the sequentially ordered data records is disposed within the temporal boundaries for the validation interval Δt_{validation}, executed training input module 176 may determine that the corresponding data record may be suitable for validation, and may perform operations that include the corresponding data record within a portion of the second subset 178B (e.g., that store the corresponding data record within a portion of consolidated data store 144 associated with second subset 178B). Executed training input module 176 may perform any of the exemplary processes described herein to determine the suitability of each additional, or alternate, one of the sequentially ordered data records of the loan-specific sets for adaptive training, or alternatively, validation, of the machine-learning or artificial-intelligence process, such as, but not limited to, the gradient-boosted, decision-tree process described herein.

Referring back to FIG. 1C, executed training input module 176 may perform operations that generate a plurality of training datasets 180 based on elements of data obtained, extracted, or derived from all or a selected portion of first subset 178A of the consolidated data records. By way of example, each of the plurality of training datasets 180 may be associated with a delinquent auto loan product having a past-due interval equivalent to one of the delinquency checkpoints described herein (e.g., a past-due interval of thirty-one days, forty-five days, or sixty-one days) and held by a corresponding one of the customers of the financial institution and further, may be associated with a corresponding temporal interval. In some instances, each of the plurality of training datasets 180 may include, among other things, an identifier of the delinquent auto loan product, a checkpoint flag identifying a corresponding one of the delinquency checkpoints associated with the past-due interval of the corresponding one of the delinquency checkpoints, a temporal identifier representative of the corresponding temporal interval within the training interval Δt_{training} described herein, and in some instances, a customer identifier associated with that corresponding customer.

Each of the plurality of training datasets 180 may also include elements of data (e.g., feature values) that characterize the corresponding one of the delinquent auto loan products, the corresponding one of the customers that hold the delinquent auto loan products, and interactions between the financial institution, the corresponding customer, and the corresponding delinquent auto loan. Further, each of training datasets 180 may also include an element of ground-truth data indicative of occurrence, or non-occurrence, of a target repossession event specified by targeting data 177 within a target temporal interval, e.g., a corresponding one of the future, checkpoint-specific temporal intervals, as described herein.

In some instances, executed training input module 176 may perform operations that identify, and obtain or extract, one or more of the features values from the filtered data records maintained within first subset 178A and associated with the corresponding one of the customers. Further, in some instances, executed training input module 176 may perform operations that compute, determine, or derive one or more of the features values based on elements of data extracted or obtained from the filtered data records maintained within first subset 178A. For example, the obtained or extracted feature values may include elements of the ingested credit bureau data described herein, which may populate collectively the filtered data records maintained within first subset 178A.

Additionally, in some examples, the obtained or extracted, or the computed, determined, or derived, feature values feature values may include, among other things, a past-due interval associated with the delinquent auto loan product (e.g., thirty-one days, forty-five days, or sixty-one days), a number of days since the last payment for the delinquent auto loan product, a number of times the delinquent auto loan product fell thirty-one to sixty days, sixty-one to ninety days, or ninety-one to 120 days past due, an amount of each payment or regular payment due on a corresponding due date, a total number of times account has been assigned for repossession, a total payment made during a prior temporal interval, such as six months, on the delinquent auto loan product, a number of days since last repossession assignment, a number of days elapsed since a most recent payment on the delinquent auto loan product, or an amount that is currently due on the delinquent auto loan product, and/or a loan-to-value ratio of a corresponding vehicle associated with the delinquent auto loan product. The disclosed embodiments are, however, not limited to these obtained or extracted feature values, or to these the computed, determined, or derived feature values and in other instances, training datasets 180 may include any additional or alternate element of data extracted or obtained from the filtered data records of first subset 178A and associated with corresponding one of the customers, and/or computed, determine, or derived from the extracted or obtained data.

Executed training input module 176 may provide training datasets 180 as an input to an adaptive training and validation module 182 of executed training engine 172. In some instances, and upon execution by the one or more processors of FI computing system 130, executed adaptive training and validation module 182 may perform operations that adaptively train the machine-learning or artificial-intelligence process against the elements of training data included within each of training datasets 180, and in accordance with the elements of targeting data 177. By way of example, and as described herein, the machine-learning or artificial-intelligence process may include a gradient-boosted, decision-tree process, and executed adaptive training and validation module 182 may perform operations that establish a plurality of nodes and a plurality of decision trees for the gradient-boosted, decision-tree process, with may ingest and process the elements of training data (e.g., the customer identifiers, the temporal identifiers, the feature values, etc.) maintained within each of the plurality of training datasets 180. Based on the execution of adaptive training and validation module 182, and on the ingestion of each of training datasets 180 by the established nodes of the gradient-boosted, decision-tree process, FI computing system 130 may perform operations that adaptively train the gradient-boosted, decision-tree process against the elements of training data included within each of training datasets 180 and in accordance with the elements of targeting data 177.

In some examples, the distributed components of FI computing system 130 may execute adaptive training and validation module 182, and may perform any of the exemplary processes described herein in parallel to train adaptively the machine-learning or artificial-intelligence process against the elements of training data included within each of training datasets 180. The parallel implementation of adaptive training and validation module 182 by the distributed components of FI computing system 130 may, in some instances, be based on an implementation, across the distributed components, of one or more of the parallelized, fault-tolerant distributed computing and analytical protocols described herein (e.g., the Apache Spark™ distributed, cluster-computing framework, etc.).

Further, and as described herein, executed adaptive training and validation module 182 may perform operations that adaptively train the machine-learning or artificial-intelligence process (e.g., the gradient-boosted, decision-tree process described herein) to predict, for a delinquent auto loan at a corresponding delinquency checkpoint (e.g., a temporal prediction point), a likelihood of an occurrence of each of a set of target repossession events during a future, checkpoint-specific temporal interval based on input datasets associated with a corresponding prior extraction interval. For example, referring to FIG. 1E, a temporal prediction point t_{pred} may represent a temporal point along timeline 179 that corresponds to one of the thirty-one-day, forty-five-day, or sixty-one day delinquency checkpoints for each of the delinquent auto loan products characterized by filtered data records 154 and 164. Further, as illustrated in FIG. 1E, the future, checkpoint-specific temporal interval may correspond to a target temporal interval Δt_{target}, and the corresponding prior extraction interval may correspond to interval Δt_{extract}. Further, the magnitude of target temporal interval Δt_{target} may vary inversely based on a magnitude of the corresponding delinquency checkpoints. By way of example, for delinquency checkpoint associated with a past-due period of thirty-one days, the magnitude of target temporal interval Δt_{target} may corresponded to six months, and for delinquency checkpoint associated with a past-due period of forty-five days, the magnitude of target temporal interval Δt_{target} may corresponded to five months, and for a for delinquency checkpoint associated with a past-due period of sixty-on days, the magnitude of target temporal interval Δt_{target} may corresponded to four months. As described herein, the elements of targeting data 177 may specify each of the delinquency checkpoints and the magnitudes of the corresponding target temporal interval Δt_{target}.

Referring back to FIG. 1C, and through the performance of these adaptive training processes, executed adaptive training and validation module 182 may perform operations that compute one or more candidate process parameters that characterize the adaptively trained, machine-learning or artificial-intelligence process, and package the candidate process parameters into corresponding portions of candidate parameter data 184. In some instances, the machine-learning or artificial-intelligence process may include a gradient-boosted, decision-tree process, the candidate process parameters included within candidate parameter data 184 for the trained gradient-boosted, decision-tree process may include, but are not limited to, a learning rate associated with the adaptively trained, gradient-boosted, decision-tree process, a number of discrete decision trees included within the adaptively trained, gradient-boosted, decision-tree process (e.g., the “n_estimator” for the adaptively trained, gradient-boosted, decision-tree process), a tree depth characterizing a depth of each of the discrete decision trees included within the adaptively trained, gradient-boosted, decision-tree process, a minimum number of observations in terminal nodes of the decision trees, and/or values of one or more hyperparameters that reduce potential process overfitting (e.g., regularization of pseudo-regularization hyperparameters). Further, and based on the performance of these adaptive training processes, executed adaptive training and validation module 182 may also generate candidate composition data 186, which specifies a candidate composition of an input dataset for the adaptively trained, gradient-boosted, decision-tree process (e.g., which be provisioned as inputs to the nodes of the decision trees of the adaptively trained, gradient-boosted, decision-tree process).

As illustrated in FIG. 1C, executed adaptive training and validation module 182 may provide candidate parameter data 184 and candidate composition data 186 as inputs to executed training input module 176 of training engine 172, which may perform any of them exemplary processes described herein to generate a plurality of validation datasets 188 having compositions consistent with candidate composition data 186. As described herein, the plurality of validation datasets 188 may, when provisioned to, and ingested by, the nodes of the decision trees of the adaptively trained, gradient-boosted, decision-tree process, enable executed training engine 172 to validate the predictive capability and accuracy of the adaptively trained, gradient-boosted, decision-tree process, for example, based on elements of ground truth data incorporated within the validation datasets 188, or based on one or more computed metrics, such as, but not limited to, computed precision values, computed recall values, and computed area under curve (AUC) for receiver operating characteristic (ROC) curves or precision-recall (PR) curves.

By way of example, each of the plurality of training datasets 180 may be associated with a delinquent auto loan product having a past-due interval equivalent to one of the delinquency checkpoints described herein (e.g., a past-due interval of thirty-one days, forty-five days, or sixty-one days) and held by a corresponding one of the customers of the financial institution and further, may be associated with a corresponding temporal interval. In some instances, each of the plurality of training datasets 180 may include, among other things, an identifier of the delinquent auto loan product, a checkpoint flag identifying a corresponding one of the delinquency checkpoints associated with the past-due interval of the corresponding one of the delinquency checkpoints, a temporal identifier representative of the corresponding temporal interval within the training interval Δt_{validation} described herein, and in some instances, a customer identifier associated with that corresponding customer. In some instances, executed training input module 176 may parse candidate composition data 186 to obtain the candidate composition of the input dataset, which not only identifies the candidate elements of loan-specific data included within each validation dataset (e.g., the candidate feature values described herein), but also a candidate sequence or position of these elements of loan-specific data within the validation dataset. Examples of these candidate feature values include, but are not limited to, one or more of the feature values extracted, obtained, computed, determined, or derived by executed training input module 176 and packaged into corresponding potions of training datasets 180, as described herein.

For example, executed training input module 176 may access the filtered data records maintained within second subset 1786, and based on portions of candidate composition data 186, may perform any of the exemplary processes described herein to obtain or extract, or to compute, determine, or derive, the loan- and/or customer-specific feature values of the validation datasets. Executed training input module 176 may package each of the loan- and/or customer-specific feature values (e.g., as obtained, extracted, computed, determined, or derived from the filtered data records within second subset 1786) into corresponding positions within loan-specific ones of validation datasets 188, e.g., in accordance with the candidate sequence or position specified within candidate composition data 186. Further, executed training input module 176 may perform any of the exemplary processes described herein to package, into an appropriate position within each of validation datasets 188, an element of ground-truth data indicative of occurrence, or non-occurrence, of one of the target repossession events during the target temporal interval Δt_{target} described herein.

In some instances, executed training input module 176 may perform any of the exemplary processes described herein to generate a corresponding one of validation datasets 188 associated with of the additional, or alternate, delinquent loan products characterized within the filtered data records of second subset 178B. Although in other instances, executed training input module 176 may perform any of the exemplary processes described herein to generate a predetermined number of discrete validation datasets specified within candidate composition data 186, or discrete validation data sets consistent with candidate composition data 186 and associated with a predetermined set of customers.

Referring back to FIG. 1C, executed training input module 176 may provide the plurality of validation datasets 188 as inputs to executed adaptive training and validation module 182. In some examples, executed adaptive training and validation module 182 may perform operations that apply the adaptively trained, machine-learning or artificial-intelligence process (e.g., the trained, gradient-boosted, decision-tree process) to respective ones of validation datasets 188 based on the candidate process parameters within candidate parameter data 184, as described herein, and that generate elements of output data based on the application of the adaptively trained, gradient-boosted, decision-tree process to the respective ones of validation datasets 188.

As described herein, each of the elements of output data may be generated through the application of the adaptively trained, machine-learning or artificial-intelligence process to a corresponding one of validation datasets 188, which includes, among other things, a loan identifier (e.g., identify a corresponding delinquent auto loan), a customer identifier (e.g., identifying a corresponding customer that colds the delinquent auto loan), a temporal identifier (e.g., identifying a corresponding temporal interval), and an element of ground-truth data. Further, as described herein, each of the elements of output data may be representative, for a delinquent auto loan product and a corresponding delinquency checkpoint, a predicted likelihood of an occurrence of each of a set of target repossession events during a future, checkpoint-specific temporal interval, e.g., the target temporal interval Δt_{target} described herein.

Executed adaptive training and validation module 182 may perform operations that compute a value of one or more metrics that characterize a predictive capability, and an accuracy, of the adaptively trained, machine-learning or artificial-intelligence process based on the generated elements of output data and corresponding ones of validation datasets 188. As described herein, the trained machine-learning or artificial-intelligence process may include the gradient-boosted, decision-tree process described herein, and the computed metrics may include, but are not limited to, one or more recall-based values for the adaptively trained, gradient-boosted, decision-tree process (e.g., “recall@5,” “recall@10,” “recall@20,” etc.), and additionally, or alternatively, one or more precision-based values for the adaptively trained, gradient-boosted, decision-tree process. Further, in some examples, the computed metrics may include a computed value of an area under curve (AUC) for a precision-recall (PR) curve associated with the adaptively trained, gradient-boosted, decision-tree process, and additional, or alternatively, computed value of an AUC for a receiver operating characteristic (ROC) curve associated with the adaptively trained, gradient-boosted, decision-tree process. The disclosed embodiments are, however, not limited to these exemplary computed metric values, and in other instances, executed adaptive training and validation module 182 may compute a value of any additional, or alternate, metric appropriate to validation datasets 188, the elements of ground-truth data, or the adaptively trained, machine-learning or artificial-intelligence process.

In some examples, executed adaptive training and validation module 182 may also perform operations that determine whether all, or a selected portion of, the computed metric values satisfy one or more threshold conditions for a deployment of the adaptively trained, machine-learning or artificial-intelligence process and a real-time application to elements of interaction or credit bureau data, as described herein. For instance, the one or more threshold conditions may specify one or more predetermined threshold values for the adaptively trained, machine-learning or artificial-intelligence process (e.g., the gradient-boosted, decision-tree process described herein), such as, but not limited to, a predetermined threshold value for the computed recall-based values, a predetermined threshold value for the computed precision-based values, and/or a predetermined threshold value for the computed AUC values. In some examples, executed adaptive training and validation module 182 that establish whether one, or more, of the computed recall-based values, the computed precision-based values, or the computed AUC values exceed, or fall below, a corresponding one of the predetermined threshold values and as such, whether the adaptively trained, machine-learning or artificial-intelligence process satisfies the one or more threshold requirements for deployment.

If, for example, executed adaptive training and validation module 182 were to establish that one, or more, of the computed metric values fail to satisfy at least one of the threshold requirements, FI computing system 130 may establish that the adaptively trained, machine-learning or artificial-intelligence process is insufficiently accurate for deployment and a real-time application to the elements of customer profile, account, transaction, application, behavioral, engagement, repossession, value, and credit bureau data described herein. Executed adaptive training and validation module 182 may perform operations (not illustrated in FIG. 1B) that transmit data indicative of the established inaccuracy to executed training input module 176, which may perform any of the exemplary processes described herein to generate one or more additional training datasets and to provision those additional encrypted training datasets to executed adaptive training and validation module 182. In some instances, executed adaptive training and validation module 182 may receive the additional training datasets, and may perform any of the exemplary processes described herein to train further the machine-learning or artificial-intelligence process against the elements of training data included within each of the additional training datasets.

Alternatively, if executed adaptive training and validation module 182 were to establish that each computed metric value satisfies threshold requirements, FI computing system 130 may deem the machine-learning or artificial-intelligence process adaptively trained, and ready for deployment and real-time application to the elements of interaction or credit bureau data described herein. In some instances, executed adaptive training and validation module 182 may generate process parameter data 190 that includes the process parameters of the trained machine-learning or artificial-intelligence process, such as, but not limited to, each of the candidate process parameters specified within candidate parameter data 184. Further, executed adaptive training and validation module 182 may also generate composition data 192, which characterizes a composition of an input dataset for the adaptively trained, machine-learning or artificial-intelligence process and identifies each of the discrete data elements within the input data set, along with a sequence or position of these elements within the input data set (e.g., as specified within candidate composition data 186). As illustrated in FIG. 1C, executed adaptive training and validation module 182 may perform operations that store process parameter data 190 and composition data 192 within the one or more tangible, non-transitory memories of FI computing system 130, such as consolidated data store 144.

B. Exemplary Processes for Predicting Temporally Separated Occurrences of Targeted Events using Trained Machine-Learning or Artificial-Intelligence Processes

In some examples, one or more computing systems associated with or operated by a financial institution, such as one or more of the distributed components of FI computing system 130, may perform operations that adaptively train a machine-learning or artificial-intelligence process to predict, for a delinquent auto loan at a corresponding delinquency checkpoint, a likelihood of an occurrence of each of a set of target repossession events during a future, checkpoint-specific temporal interval. The delinquency checkpoints may include, among other things, a past-due interval of thirty-one days (e.g., two successive missed monthly payments), a past-due interval of forty-five days, and past-due interval of sixty-one days (e.g., three successive missed monthly payments), future, checkpoint-specific temporal interval may include “look-ahead window” of six months, five months, and four months associated with respective ones of the thirty-one-day delinquency checkpoint, forty-five-day delinquency checkpoint, and sixty-one-day delinquency checkpoint.

As described herein, the machine-learning or artificial-intelligence process may include an ensemble or decision-tree process, such as a gradient-boosted decision-tree process (e.g., XGBoost process), and certain of the exemplary training and validation processes described herein may generate, and utilize, training datasets associated with a first prior temporal interval (e.g., a “training” interval), and using validation datasets associated with a second, and distinct, prior temporal interval (e.g., an out-of-time “validation” interval). In some examples, the training and validation data may include elements of data, e.g., feature values, characterizing delinquent auto loan products associated with a past-due interval of thirty-one days, forty-five days, and/or sixty-one days (e.g., the delinquency checkpoints described herein) and characterizing the customers that hold these delinquent auto loan products. Responsive to a determination that the machine-learning or artificial-intelligence process is adaptively trained and ready for deployment, the distributed components of FI computing system 130 may perform any of the exemplary processes described herein to generate one or more elements of parameter data (e.g., process parameter data 190 of FIG. 1C) that include the process parameters of the adaptively trained machine-learning or artificial-intelligence process, and to generate one or more elements of composition data (e.g., composition data 192 of FIG. 1C) that characterizes a composition of an input dataset for the adaptively trained machine-learning or artificial-intelligence process.

Further, the distributed components of FI computing system 130 may also perform any of the exemplary processes described herein to generate loan-specific input datasets characterizing delinquent auto loan products associated with a past-due interval of thirty-one days, forty-five days, and/or sixty-one days (e.g., the delinquency checkpoints described herein), and characterizing the customers that hold these delinquent auto loan products. The distributed components of FI computing system 130 may also perform operations, described herein, to apply the adaptively trained machine-learning or artificial-intelligence process (e.g., the adaptively trained, gradient-boosted, decision-tree process described herein) to each of the input datasets in accordance with the elements of the process data. Based on the application of the adaptively trained machine-learning or artificial-intelligence process to each of the input datasets, the distributed components of FI computing system 130 may generate, for each of the delinquent auto loan products and at the corresponding ones of the delinquency checkpoints, loan-specific elements of output data indicative of a likelihood of an occurrence of each of a set of target repossession events during a future, checkpoint-specific temporal interval.

For example, the target repossession events may include, but are not limited to, a repossession event without reinstatement, a reinstatement event, a skip-charge event, or a non-occurrence of any event, and the elements of output data associated with each of the delinquent auto loan products and the corresponding one of the delinquency checkpoints may include a numerical value indicative of the predicated likelihood of each of the target repossession events, e.g., with zero indicating a minimum predicted likelihood, and with unity being indicative of a maximum predicted likelihood. Further, in some instances, the numerical values associated with the target repossession events may be scaled, such that for each of the delinquent auto loan products and the corresponding one of the delinquency checkpoints, the numerical values sum to unity, e.g., indicating an expected occurrence of one of the target repossession events.

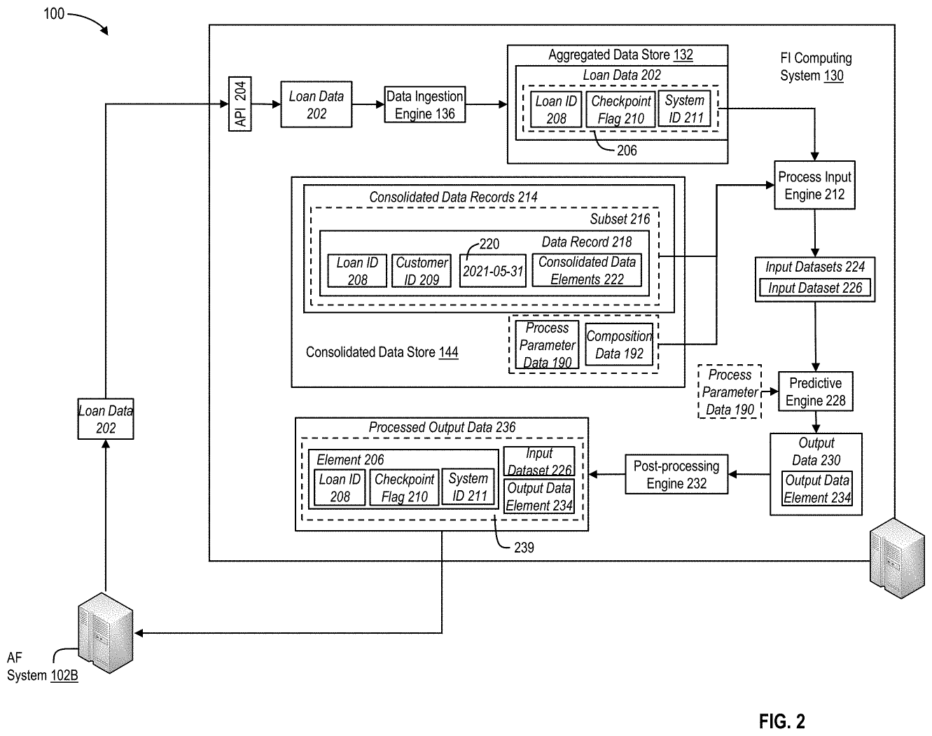

Referring to FIG. 2, aggregated data store 132 of FI computing system 130 may maintain one or more elements of loan data 202. In some instances, each of the one or more elements of loan data 202 may be associated with a delinquent auto loan characterized by a past-due interval equivalent to one of the delinquency checkpoints (e.g., a past due interval of thirty-one days, forty-five days, or sixty-one days) and held by a corresponding customer of the financial institution. FI computing system 130 may, for example, receive all, or a selected portion, of loan data 202 from AF system 102B, which originates and manages each of the delinquent auto loan products. In some instances, an application program executed by the one or more processors of AF system 1026 may transmit portions of loan data 202 across network 120 to FI computing system 130. The transmitted portions may be encrypted using a corresponding encryption key, such as a public cryptographic key associated with FI computing system 130, and a programmatic interface established and maintained by FI computing system 130, such as application programming interface (API) 204, may receive the portions of loan data 202 from AF system 102B.

API 204 may, for example, route each of the elements of loan data 202 to executed data ingestion engine 136, which may perform operations that store the elements of loan data 202 within one or more tangible, non-transitory memories of FI computing system 130, such as within aggregated data store 132. In some instances, and as described herein, the received elements of loan data 202 may be encrypted, and executed data ingestion engine 136 may perform operations that decrypt each of the encrypted elements of loan data 202 using a corresponding decryption key (e.g., a private cryptographic key associated with FI computing system 130) prior to storage within aggregated data store 132. Further, although not illustrated in FIG. 2, aggregated data store 132 may also store one or more additional elements of loan data characterizing additional delinquent auto loan products characterized by respective past-due interval equivalent to one of the delinquency checkpoints (e.g., a past due interval of thirty-one days, forty-five days, or sixty-one days), and executed data ingestion engine 136 may perform one or more synchronization operation that merge the received elements of loan data 202 with the previously stored elements of loan data, and that eliminate any duplicate elements existing among the received elements of loan data 202 with the previously stored elements of loan data (e.g., through an invocation of an appropriate Java-based SQL “merge” command).

As described herein, each of the elements of loan data 202 may be associated with, and include a unique identifier of, a delinquent auto loan held by a customer of the financial institution, and FI computing system 130 may receive each of the elements of loan data 202 from AF system 102B. For example, as illustrated in FIG. 2, element 206 of loan data 202 may include a loan identifier 208 assigned to corresponding one of the delinquent auto loan products by AF system 1026 at origination (e.g., an alphanumeric character string, etc.), a checkpoint flag 210 indicating that a past-due interval of the corresponding delinquent loan represents one of the thirty-one-day, forty-five-days, or sixty-one-day delinquency checkpoints, and a system identifier 211 associated with AF system 102B (e.g., an Internet Protocol (IP) address, a media access control (MAC) address, etc.). Further, although not illustrated in FIG. 2, each additional, or alternate, element of loan data 202 may be associated with an additional delinquent auto loan product, and may include a loan identifier associated with that additional delinquent auto loan product, corresponding checkpoint flag, and a system identifier associated with AF system 102B.

As described herein, FI computing system 130 may perform any of the exemplary processes described herein to generate an input dataset associated with each of the delinquent auto loan products identified by the discrete elements of loan data 202, and to apply a adaptively trained, machine-learning or artificial process (e.g., the gradient-boosted, decision-tree process described herein) to each of the input datasets, in accordance with a predetermined temporal schedule (e.g., on a daily, weekly, or monthly basis), or in response to a detection of a triggering event. By way of example, and without limitation, the triggering event may correspond to a detected change in a composition of the elements of loan data 202 maintained within aggregated data store (e.g., to an ingestion of additional elements of loan data 202, etc.) or to a receipt of an explicit request received from AF system 102B.

In some instances, and in accordance with the predetermined temporal schedule, or upon detection of the triggering event, a process input engine 212 executed by FI computing system 130 may perform operations that access the elements of loan data 202 maintained within aggregated data store 132, and that obtain the loan identifier and checkpoint flag maintained within a corresponding one of the accessed elements of loan data 202. For example, as illustrated in FIG. 2, executed process input engine 212 may access element 206 of loan data 202 (e.g., as maintained within aggregated data store 132) and obtain loan identifier 208, which includes, but is not limited to, the alphanumeric character string assigned to the corresponding delinquent auto loan product, and checkpoint flag 210, which indicates the delinquent auto loan product is associated with a past-due interval of forty-five days.

Executed process input engine 212 may also access consolidated data store 144, and perform operations that identify, within consolidated data records 214, a subset 216 of consolidated data records that include loan identifier 208 and as such, are associated with the corresponding delinquent auto loan identified by element 206 of loan data 202. For example, and as described herein, each of consolidated data records 214 may include a corresponding loan identifier (e.g., an alphanumeric character string, etc.), a corresponding customer identifier (e.g., an alphanumeric character string, a customer name, etc.), a corresponding temporal identifier (e.g., that identifies the corresponding temporal interval), and one or more consolidated data elements associated with the corresponding delinquent auto loan product and the corresponding customer. Further, although not illustrated in FIG. 2, each of consolidated data records 214 may also include a checkpoint flag confirming that a past-due amount associated with each of the delinquent auto loan products corresponds to one of the delinquency checkpoints described herein.

In some instances, and as illustrated in FIG. 2, each of subset 216 may include loan identifier 208 and as such, may be associated with the corresponding delinquent auto loan identified by element 206 of loan data 202. By way of example, data record 218 of subset 216 may include loan identifier 208, a customer identifier 209 to identify a customer than holds the corresponding delinquent auto loan product, a corresponding temporal identifier 220 (e.g., “2022 Mar. 31,” indicating a temporal interval spanning May 1, 2021, through Mar. 1, 2022), and consolidated data elements 222, which identify and characterize the corresponding delinquent auto loan product and customer during the temporal interval spanning May 1, 2021, through Mar. 1, 2022. Further, although not illustrated in FIG. 2, each additional, or alternate, data record within subset 216 may include loan identifier 208, a corresponding customer identifier, a temporal identifier of a corresponding temporal interval, a corresponding checkpoint flag, and corresponding elements of consolidated data that identify and characterize the corresponding delinquent auto loan product and customer during the corresponding temporal interval.

Executed process input engine 212 may also perform operations that obtain, from consolidated data store 144, elements of composition data 192 characterize a composition of an input dataset for the adaptively trained machine-learning or artificial-intelligence process (e.g., the adaptively trained, gradient-boosted, decision-tree process, as described herein). In some instances, executed process input engine 212 may parse composition data 192 to obtain the composition of the input dataset, which not only identifies the elements of loan-specific data included within each input dataset (e.g., input feature values, as described herein), but also a specified sequence or position of these input feature values within the input dataset. Examples of these input feature values include, but are not limited to, one or more of the candidate feature values extracted, obtained, computed, determined, or derived by executed training input module 176 and packaged into corresponding potions of training datasets 180, as described herein.

In some instances, and based on the parsed portions of composition data 192, executed process input engine 212 may that identify, and obtain or extract, one or more of the input feature values from one or more of data records maintained within subset 216 of consolidated data records 214 and associated with temporal intervals disposed within the extraction interval Δt_{extract}, as described herein. Executed process input engine 212 may perform operations that package the obtained, or extracted, input feature values within a corresponding one of input datasets 224, such as input dataset 226 associated with the particular delinquent auto loan product identified by element 206 of loan data 202, in accordance with their respective, specified sequences or positions. Further, in some examples, and based on the parsed portions of composition data 192, executed process input engine 212 may perform operations that compute, determine, or derive one or more of the input features values based on elements of data extracted or obtained from the additional ones of the consolidated data records, as described herein. Executed process input engine 212 may perform operations that package each of the computed, determined, or derived input feature values into portions of input datasets 224 in accordance with their respective, specified sequences or positions.

Through an implementation of these exemplary processes, executed process input engine 212 may populate an input dataset associated with the corresponding delinquent auto loan identified by element 206 of loan data 202, such as input dataset 226 of input datasets 224, with input feature values obtained or extracted from, or computed, determined or derived from elements of data within the data records of subset 216. Further, in some instances, executed process input engine 212 may also perform any of the exemplary processes described herein to generate, and populate with input feature values, an additional one of input datasets 224 for each of the additional, or alternate, delinquent auto loan products associated with additional, or alternate, elements of loan data 202. Executed process input engine 212 may package each of the discrete, loan-specific input datasets within input datasets 224, and executed process input engine 212 may provide input datasets 224 as an input to a predictive engine 228 executed by the one or more processors of FI computing system 130.

As illustrated in FIG. 2, executed predictive engine 228 may perform operations that obtain, from consolidated data store 144, process parameter data 190 that includes one or more process parameters of the adaptively trained, machine-learning or artificial-intelligence process. For example, and as described herein, the process parameters included within process parameter data 190 may include, but are not limited to, a learning rate associated with the adaptively trained, gradient-boosted, decision-tree process, a number of discrete decision trees included within the adaptively trained, gradient-boosted, decision-tree process (e.g., the “n_estimator” for the adaptively trained, gradient-boosted, decision-tree process), a tree depth characterizing a depth of each of the discrete decision trees included within the adaptively trained, gradient-boosted, decision-tree process, a minimum number of observations in terminal nodes of the decision trees, and/or values of one or more hyperparameters that reduce potential process overfitting (e.g., regularization of pseudo-regularization hyperparameters).

In some examples, and based on portions of process parameter data 190, executed predictive engine 228 may perform operations that establish a plurality of nodes and a plurality of decision trees for the adaptively trained, gradient-boosted, decision-tree process, each of which receive, as inputs (e.g., “ingest”), corresponding elements of input datasets 224. Further, and based on the execution of predictive engine 228, and on the ingestion of input datasets 224 by the established nodes and decision trees of the adaptively trained, gradient-boosted, decision-tree process, FI computing system 130 may perform operations that apply the adaptively trained, gradient-boosted, decision-tree process to each of the input datasets of input datasets 224, including input dataset 226, and that generate an element of output data 230 associated with a corresponding one of input datasets 224, and as such, a corresponding one of the delinquent auto loan products identified by the elements of loan data 202.

As described herein, each of the generated elements of output data 230 may include, for a corresponding one of the delinquent auto loan products and a corresponding one of the delinquency checkpoints, a numerical value indicative of the predicted likelihood of an occurrence of each of the target repossession events during the future, checkpoint-specific temporal interval, e.g., with zero indicating a minimum predicted likelihood, and with unity being indicative of a maximum predicted likelihood. Further, in some instances, the numerical values associated with the target repossession events may be scaled, such that for each of the delinquent auto loan products and the corresponding one of the delinquency checkpoints, the numerical values sum to unity, e.g., indicating an expected occurrence of one of the target repossession events.

As illustrated in FIG. 2, executed predictive engine 228 may provide the generated elements of output data 230 (e.g., either alone, or in conjunction with corresponding ones of input datasets 224) as an input to a post-processing engine 232 executed by the one or more processors of FI computing system 130. In some instances, and upon receipt of the generated elements of output data 230 (e.g., and additionally, or alternatively, the corresponding ones of input datasets 224), executed post-processing engine 232 may perform operations that access the elements of loan data 202 maintained within consolidated data store 144, and associate each of the elements of loan data 202 (e.g., that identify a corresponding one of the delinquent auto loan products) with a corresponding one of the elements of output data 230 (e.g., that include numerical scores indicative of the predicted likelihood that corresponding ones of the customers will be involved in each of the target repossession events during the future temporal interval), and a corresponding one of input datasets 224, which include the feature values.

By way of example, output data element 234 of output data 230 may be associated with the delinquent auto loan identified by element 206 of loan data 202 and associated with a past-due interval of forty-five days, and may include a numerical scores indicative of the predicted likelihood of an occurrence of each of the target repossession events, including repossession without reinstatement, reinstatement, skip-charge, and event non-occurrence, during the future, five-month temporal interval associated with the forty-five-day delinquent checkpoint. Executed post-processing engine 232 may, in some instances, associate element 206 of loan data 202 with output data element 234 of output data 230 and with input dataset 226 of input datasets 224. Executed post-processing engine 232 may perform any of these exemplary processes to associate each additional, or alternate, one of the elements of output data 230 with a corresponding one of the elements of loan data 202 and a corresponding one of input datasets 224. Executed post-processing engine 232 may also perform operations that package linked element 206 of loan data 202, output data element 234, and input dataset 226 (and each additional or alternate loan-specific set of linked elements of customer data, output data elements, and input datasets) into corresponding portions of processed output data 236.

As illustrated in FIG. 2, FI computing system 130 may perform operations that transmit all, or a selected portion of, processed output data 236 to AF system 102B. Further, although not illustrated in FIG. 2, FI computing system 130 may also encrypt all, or a selected portion of, processed output data 236 prior to transmission across network 120 using a corresponding encryption key, such as, but not limited to, a corresponding public cryptographic key associated with AF system 102B.

Although not illustrated in FIG. 2, AF system 102B may receive processed output data 236, which includes the loan-specific sets of linked elements of loan data, output data elements, and input datasets, from FI computing system 130. In some instances, processed output data 236 may be encrypted, and AF system 102B may decrypt portions of processed output data 236 with a corresponding decryption key, e.g., a private cryptographic key associated with AF system 102B. In some examples, AF system 102B may access each of the loan-specific sets of linked elements of loan data, output data elements, and input datasets maintained within processed output data 236, and may perform operations that select one or more treatment processes for application to corresponding ones of the delinquent auto loan products, or that modify one or more treatment processes currently applied to the corresponding ones of the delinquent auto loan products, based on the output data elements.

For example, and based on the output data element 234 included within elements 239 of processed output data 236, AF system 102B may determine that the delinquent auto loan associated with loan identifier 208 may represent a risk for write-off as a skip charge (e.g., characterized by a numerical score of 0.81), and minimal risks for repossession without reinstatement, reinstatement, or event non-occurrence (e.g., characterized by numerical scores of 0.08, 0.04, and 0.07, respectively). Based on this determination, AF system 102B may perform additional operations that obtain regular updates on the locations of the underlying vehicle and/or the customer that holds the delinquent auto loan (e.g., to know where the vehicle is located) or, in the case of substantial skip-charge risk, accelerate the repossession of the vehicle.

In other examples, and based on an additional output data element maintained within processed output data 236, AF system 102B may determine that a customer holding an additional delinquent auto loan product (e.g., associated with a corresponding loan identifier maintained in conjunction with the additional output data element in an element of processed output data 236) may be characterized by an increased propensity for reinstatement (e.g., characterized by a numerical score of 0.91). AF system 102B may, for instance, perform operations that increase an outreach to the customer in an effort to resolve the delinquent auto loan without advancing towards repossession or reinstatement, e.g., to resolve the delinquency early in the past-due interval. The disclosed embodiments are, however, not limited to these exemplary treatment applied based on corresponding ones of the predictive likelihoods of the occurrences of the target repossession events, and in other instances, AF system 1026 may select and apply, or modify, any additional or alternate treatment that would be appropriate to a corresponding one of the delinquent auto loan products, the corresponding delinquency checkpoints, and the predicted likelihoods of the occurrences of each of the target repossessions events during the future, checkpoint-specific temporal intervals.

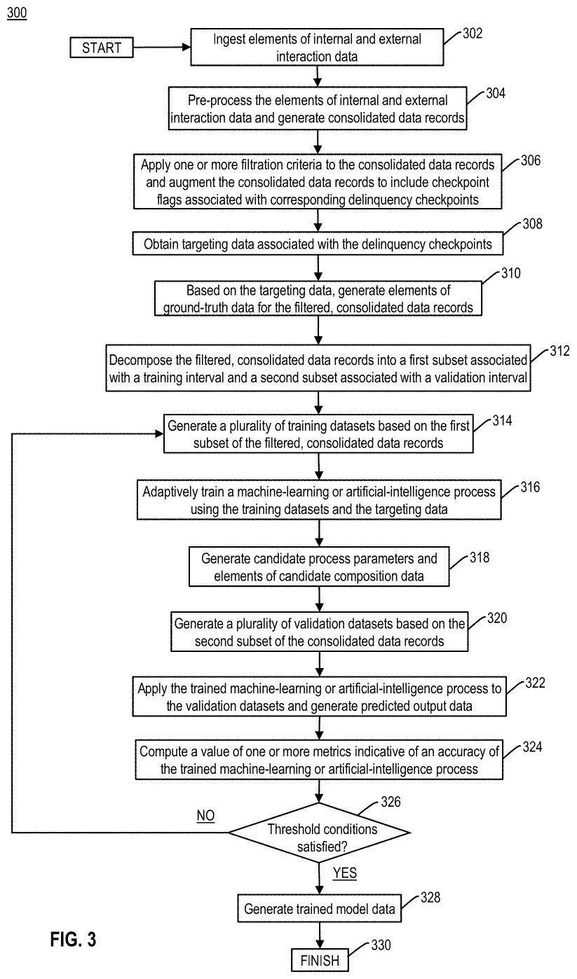

FIG. 3 is a flowchart of an exemplary process 300 for adaptively training a machine-learning or artificial-intelligence process to predict, for a delinquent auto loan product associated with a corresponding delinquency checkpoint, a likelihood of an occurrence of each of a set of target repossession events involving a delinquent auto loan product during a future, checkpoint-specific temporal interval using training datasets associated with a first prior temporal interval, and using validation datasets associated with a second, and distinct, prior temporal interval. As described herein, the delinquent auto loan product may be held by a customer of the financial institution, and may be associated with a past-due interval measured relative to a due date of an initial missed payment (e.g., the initially missed due date described herein). Further, and as described herein, the delinquency checkpoints may include, among other things, a past-due interval of thirty-one days (e.g., two successive missed monthly payments), a past-due interval of forty-five days, and past-due interval of sixty-one days (e.g., three successive missed monthly payments), and the future, checkpoint-specific temporal interval may include a “look-ahead window” of six months, five months, and four months associated with respective ones of the thirty-one-day delinquency checkpoint, forty-five-day delinquency checkpoint, and sixty-one-day delinquency checkpoint

As described herein, the machine-learning or artificial-intelligence process may include an ensemble or decision-tree process, such as a gradient-boosted decision-tree process (e.g., XGBoost process), and the training and validation datasets may include, but are not limited to, values of adaptively selected features obtained, extracted, or derived from the filtered data records maintained within consolidated data store 144, e.g., from data elements maintained within the discrete data records of filtered data records 154 or the additional filtered data records 164. In some examples, described herein, the training and validation datasets may include elements of data, e.g., feature values, characterizing delinquent auto loan products associated with a past-due interval of thirty-one days, forty-five days, and/or sixty-one days (e.g., the delinquency checkpoints described herein) and characterizing the customers that hold these delinquent auto loan products. In some instances, one or more computing systems, such as, but not limited to, one or more of the distributed components of FI computing system 130, may perform one or of the steps of exemplary process 300.

Referring to FIG. 3, FI computing system 130 may establish a secure, programmatic channel of communication with one or more source computing systems, such as source systems 102 of FIG. 1A, and may perform operations to obtain, from the source computing systems, elements of internal interaction data (e.g., including customer profile, transaction, and account data from enterprise system 102A, and application data 108, behavioral data 110, engagement data 112, repossession data 114, and value data 116 from the AF system 102B), and external interaction data (e.g., credit bureau data 118A from credit bureau system 102C) that identify and characterize one or more customers of the financial institution during corresponding temporal intervals (e.g., in step 302 of FIG. 3). FI computing system 130 may also perform operations that store (or ingest) the obtained elements of internal and external data within one or more accessible data repositories, such as aggregated data store 132 (e.g., also in step 302 of FIG. 3). In some instances, FI computing system 130 may perform the exemplary processes described herein to obtain and ingest the elements of internal and external customer data in accordance with a predetermined temporal schedule (e.g., on a daily, weekly, monthly basis), or a continuous streaming basis, across the secure, programmatic channel of communication.

Further, FI computing system 130 may access the ingested elements of internal and external interaction data, and may perform any of the exemplary processes described herein to pre-process the ingested elements of internal and external interaction data elements (e.g., the elements of customer profile, account, transaction, application, behavioral, engagement, repossession, value, and credit bureau data described herein) and generate one or more consolidated data records (e.g., in step 304 of FIG. 3). As described herein, the FI computing system 130 may store each of the consolidated data records within one or more accessible data repositories, such as consolidated data store 144 (e.g., also in step 304 of FIG. 3).

For example, and as described herein, each of the consolidated data records may be associated with an originated auto loan product held by a corresponding one of the customers of the financial institution and with a corresponding temporal interval (e.g., during which FI computing system 130 ingested corresponding elements of the internal and external interaction data described herein). Each of the consolidated data records may include a loan identifier of the corresponding auto loan product (e.g., an alphanumeric character string, etc.), a temporal interval that identifies a corresponding temporal interval (e.g., indicating a period corresponding to one of the delinquency checkpoints, etc.), and in some instances, a customer identifier associated with the customer that holds the corresponding delinquent auto loan product. Each of the consolidated data records may also include one or more consolidated elements of customer profile, account, transaction, application, behavioral, engagement, repossession, value, and credit bureau data that characterize the corresponding originated auto loan product or the corresponding customer during the corresponding temporal interval associated with the temporal identifier.

FI computing system 130 may also perform any of the exemplary processes described herein to filter the consolidated data records accordance with one or more filtration criteria (e.g., in step 306 of FIG. 3). By way of example, FI computing system may perform operations, in step 306, that identify subsets of the consolidated data records that characterize, respectively, delinquent auto loan products associated with past due balances and corresponding past-due intervals, and originated auto loan products without past-due balances, that deem the subset of the consolidated data records that characterize the auto loan products without past-due balances unsuitable for training and validating the machine-learning or artificial intelligence processes described herein, and that exclude (e.g., filter out) those data records that characterize the auto loan products without past-due balances from the consolidated data records. Further, in step 306, executed filtration engine 152 may also perform operations, described herein, to filer the consolidated data record and maintained a subset of the consolidated data records that characterize the delinquent auto loan products, having a past-due interval equivalent to one of the delinquency checkpoints described herein, e.g., a past-due interval of thirty-one days, forty-five days, or sixty-one days. Executed filtration engine 152 may deem the maintained subset of the consolidated data records as suitable for training and validating the machine-learning or artificial intelligence processes described herein, and may perform operations that package, into each of the maintained subset of consolidated data records, a checkpoint flag that associates the past-due interval of the corresponding delinquent auto loan products with one of delinquency checkpoints described herein, such the past-due interval of thirty-one days, forty-five days, or sixty-one days (e.g., also in step 306 of FIG. 3).

FI computing system 130 may perform operations, described herein, that one or more elements of targeting data associated with the delinquency checkpoints, and corresponding future, checkpoint-specific temporal intervals associated with the delinquency checkpoints (e.g., in step 308 of FIG. 3). As described herein, the elements of targeting data may identify each of the delinquency checkpoints (e.g., a past-due interval of thirty-one days, forty-five days, or sixty-one days), the future, checkpoint-specific temporal intervals associated with corresponding ones of the delinquency checkpoints (e.g., “look-ahead windows” of six months, five months, and four months associated with respective ones of the thirty-one-day delinquency checkpoint, forty-five-day delinquency checkpoint, and sixty-one-day delinquency checkpoint), and one or more target repossession events, such as, but not limited to, a repossession event without reinstatement, a reinstatement event, a skip-charge event, or a non-occurrence of any event. Further, based on the elements of targeted data and the ingested elements of internal and external customer data, FI computing system 130 also perform any of the exemplary processes to augment each of the filtered, consolidated data records to include additional information characterizing a ground truth associated with the corresponding customer and temporal interval, as established by the corresponding pair of customer and temporal identifiers of each of the filtered and consolidated data records (e.g., in step 310 of FIG. 3).

FI computing system 130 may also perform any of the exemplary processes described herein to decompose the filtered and consolidated data records into (i) a first subset having temporal identifiers associated with a first prior temporal interval (e.g., the training interval Δt_{training}, as described herein) and (ii) a second subset having temporal identifiers associated with a second prior temporal interval (e.g., the validation interval Δt_{validation}, as described herein), which may be separate, distinct, and disjoint from the first prior temporal interval (e.g., in step 312 of FIG. 3). By way of example, portions of the filtered and consolidated data records within the first subset may be appropriate to train adaptively the machine-leaning or artificial process (e.g., the gradient-boosted decision process described herein during the training interval Δt_{training}, and portions of the consolidated records within the second subset may be appropriate to validating the adaptively trained gradient-boosted decision process during the validation interval Δt_{validation}.

In some instances, FI computing system 130 may perform any of the exemplary processes described herein to generate a plurality of training datasets based on elements of data obtained, extracted, or derived from all or a selected portion of the first subset of the filtered and consolidated data records (e.g., in step 314 of FIG. 3). By way of example, each of the plurality of training datasets may be associated with a corresponding one of the customers of the financial institution, a corresponding delinquent auto loan product held by the corresponding customer and having a past-due interval equivalent to one of the delinquent checkpoints (e.g., a past-due interval of thirty-one days, forty-five days, or sixty-one days), and a corresponding temporal interval, and may include, among other things a customer identifier associated with that corresponding customer, a temporal identifier representative of the corresponding temporal interval, and a checkpoint flag indicative of the corresponding one of the delinquency checkpoints, as described herein.

Further, and as described herein, each of the plurality of training datasets may also include elements of data (e.g., feature values) that characterize the corresponding one of the customers, the corresponding customer's auto finance loan with the financial institution, and/or an occurrence of delinquency events involving the corresponding customer during a temporal interval disposed prior to the corresponding temporal interval, e.g., during the extraction interval Δt_{extract} described herein. Each of the plurality of training datasets may also include an element of ground-truth data, described herein, indicative of the presence or absence of an actual target repossession event associated with the corresponding delinquent auto loan product during a future, checkpoint-specific temporal interval (e.g., a target prediction interval Δt_{target}), such as, but not limited to, a four-month period, a five-month period, or a six-month period depending on the delinquency event during the extraction interval.

Based on the plurality of training datasets, FI computing system 130 may also perform any of the exemplary processes described herein to train adaptively the machine-learning or artificial-intelligence process to predict, for a delinquent auto loan product associated with a corresponding delinquency checkpoint, a likelihood of an occurrence of each of a set of target repossession events during a future, checkpoint-specific temporal interval (e.g., in step 316 of FIG. 3). For example, and as described herein, the machine-learning or artificial-intelligence process may include a gradient-boosted decision-tree process, and FI computing system 130 may perform operations that establish a plurality of nodes and a plurality of decision trees for the gradient-boosted, decision-tree process, which may ingest and process the elements of training data (e.g., the customer identifiers, the temporal identifiers, the feature values, etc.) maintained within each of the plurality of training datasets, and that adaptively train the gradient-boosted, decision-tree process against the elements of training data included within each of the plurality of the training datasets.

In some examples, the distributed components of FI computing system 130 may perform any of the exemplary processes described herein in parallel to establish the plurality of nodes and a plurality of decision trees for the gradient-boosted, decision-tree process, and to adaptively train the gradient-boosted, decision-tree process against the elements of training data included within each of the plurality of the training datasets. The parallel implementation of these exemplary adaptive training processes by the distributed components of FI computing system 130 may, in some instances, be based on an implementation, across the distributed components, of one or more of the parallelized, fault-tolerant distributed computing and analytical protocols described herein.

Through the performance of these adaptive training processes, FI computing system 130 may compute one or more candidate process parameters that characterize the adaptively trained machine-learning or artificial-intelligence process, such as, but not limited to, candidate process parameters for the adaptively trained, gradient-boosted, decision-tree process described herein (e.g., in step 318 of FIG. 3). In some instances, and for the adaptively trained, gradient-boosted, decision-tree process, the candidate process parameters included within candidate process data may include, but are not limited to, a learning rate associated with the adaptively trained, gradient-boosted, decision-tree process, a number of discrete decision trees included within the adaptively trained, gradient-boosted, decision-tree process (e.g., the “n_estimator” for the adaptively trained, gradient-boosted, decision-tree process), a tree depth characterizing a depth of each of the discrete decision trees included within the adaptively trained, gradient-boosted, decision-tree process, a minimum number of observations in terminal nodes of the decision trees, and/or values of one or more hyperparameters that reduce potential process overfitting (e.g., regularization of pseudo-regularization hyperparameters). Further, and based on the performance of these adaptive training processes, FI computing system 130 may perform any of the exemplary processes described herein to generate candidate composition data, which specifies a candidate composition of an input dataset for the adaptively trained machine-learning or artificial intelligence process, such as the adaptively trained, gradient-boosted, decision-tree process described herein (e.g., also in step 318 of FIG. 3).

Further, FI computing system 130 may perform any of the exemplary processes described herein to access the second subset of the consolidated data records, and to generate a plurality of validation subsets having compositions consistent with the candidate composition data (e.g., in step 320 of FIG. 3). As described herein, each of the plurality of the validation datasets may be associated with a corresponding one of the customers of the financial institution, a corresponding delinquent auto loan product held by the corresponding customer and having a past-due interval equivalent to one of the delinquent checkpoints (e.g., a past-due interval of thirty-one days, forty-five days, or sixty-one days), and with a corresponding temporal interval within the validation interval Δt_{validation}, and may include a customer identifier associated with the corresponding one of the customers, a checkpoint flag indicative of the corresponding one of the delinquency checkpoints, and a temporal identifier that identifies the corresponding temporal interval.

Further, each of the plurality of the validation datasets may also include one or more feature values that are consistent with the candidate input data, associated with the corresponding one of the customers, and obtained, extracted, or derived from corresponding ones of the accessed second subset of the consolidated data records (e.g., during the corresponding extraction interval Δt_{extract}, as described herein). Each of the plurality of validation datasets may also include an element of ground-truth data, described herein, indicative of the presence or absence of an actual target repossession event associated with the corresponding delinquent auto loan product during a future, checkpoint-specific temporal interval (e.g., a target prediction interval Δt_{target}), such as, but not limited to, a four-month period, a five-month period, or a six-month period depending on the delinquency event during the extraction interval.

In some instances, FI computing system 130 may perform any of the exemplary processes described herein to apply the adaptively trained machine-learning or artificial intelligence process (e.g., the adaptively trained, gradient-boosted, decision-tree process described herein) to respective ones of the validation datasets, and to generate corresponding elements of output data based on the application of the adaptively trained machine-learning or artificial intelligence process to the respective ones of the validation datasets (e.g., in step 322 of FIG. 3). As described herein, each of the generated elements of output data may be associated with a respective one of the validation datasets and as such, a corresponding one of the customers of the financial institution and a corresponding one of the delinquent loan products held by the corresponding customers. Further, each of the generated elements of output data may also include a numerical score (e.g., ranging from zero to unity) indicative of a predicted a likelihood of an occurrence of each of a set of target repossession events during a future, checkpoint-specific temporal interval.

Further, and as described herein, the distributed components of FI computing system 130 may perform any of the exemplary processes described herein in parallel to validate the adaptively trained machine-learning or artificial intelligence process described herein based on the application of the adaptively trained machine-learning or artificial intelligence process (e.g., configured in accordance with the candidate process parameters) to each of the validation datasets. The parallel implementation of these exemplary adaptive validation processes by the distributed components of FI computing system 130 may, in some instances, be based on an implementation, across the distributed components, of one or more of the parallelized, fault-tolerant distributed computing and analytical protocols described herein.

In some examples, FI computing system 130 may perform any of the exemplary processes described herein to compute a value of one or more metrics that characterize a predictive capability, and an accuracy, of the adaptively trained machine-learning or artificial intelligence process (such as the adaptively trained, gradient-boosted, decision-tree process described herein) based on the generated elements of output data and corresponding ones of the validation datasets (e.g., in step 324 of FIG. 3), and to determine whether all, or a selected portion of, the computed metric values satisfy one or more threshold conditions for a deployment of the adaptively trained machine-learning or artificial intelligence process (e.g., in step 326 of FIG. 3). As described herein, and for the adaptively trained, gradient-boosted, decision-tree process, the computed metrics may include, but are not limited to, one or more recall-based values (e.g., “recall@5,” “recall@10,” “recall@20,” etc.), one or more precision-based values for the adaptively trained, gradient-boosted, decision-tree process, and additionally, or alternatively, a computed value of an area under curve (AUC) for a precision-recall (PR) curve or a computed value of an AUC for a receiver operating characteristic (ROC) curve associated with the adaptively trained, gradient-boosted, decision-tree process.

Further, and as described herein, the threshold requirements for the adaptively trained, gradient-boosted, decision-tree process may specify one or more predetermined threshold values, such as, but not limited to, a predetermined threshold value for the computed recall-based values, a predetermined threshold value for the computed precision-based values, and/or a predetermined threshold value for the computed AUC values. In some examples, FI computing system 130 may perform any of the exemplary processes described herein to establish whether one, or more, of the computed recall-based values, the computed precision-based values, or the computed AUC values exceed, or fall below, a corresponding one of the predetermined threshold values and as such, whether the adaptively trained, gradient-boosted, decision-tree process satisfies the one or more threshold requirements for deployment.

If, for example, FI computing system 130 were to establish that one, or more, of the computed metric values fail to satisfy at least one of the threshold requirements (e.g., step 326; NO), FI computing system 130 may establish that the adaptively trained machine-learning or artificial-intelligence process (e.g., the adaptively trained, gradient-boosted, decision-tree process) is insufficiently accurate for deployment and a real-time application to the elements of customer profile, account, transaction, application, behavioral, engagement, repossession, value, and credit bureau data described herein. Exemplary process 300 may, for example, pass back to step 314, and FI computing system 130 may perform any of the exemplary processes described herein to generate additional training datasets based on the elements of the consolidated data records maintained within the first subset.

Alternatively, if FI computing system 130 were to establish that each computed metric value satisfies threshold requirements (e.g., step 326; YES), FI computing system 130 may deem the machine-learning or artificial intelligence process (e.g., the gradient-boosted, decision-tree process described herein) adaptively trained and ready for deployment and real-time application to the elements of customer profile, account, transaction, application, behavioral, engagement, repossession, value, and credit bureau data described herein, and may perform any of the exemplary processes described herein to generate trained process data that includes the candidate process parameters and candidate composition data associated with the of the adaptively trained machine-learning or artificial intelligence process (e.g., in step 328 of FIG. 3). Exemplary process 300 is then complete in step 330.

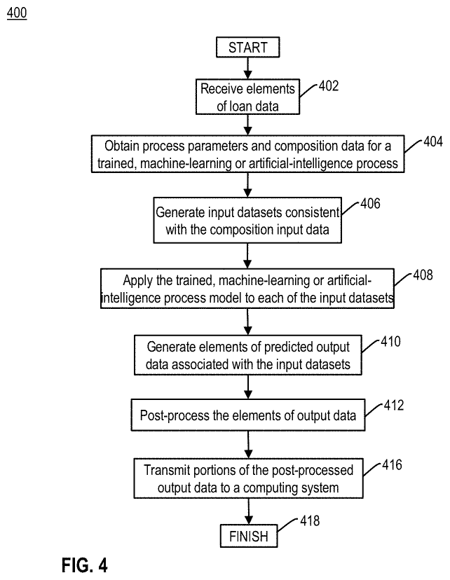

FIG. 4 is a flowchart of an exemplary process 400 for predicting a likelihood of an occurrence of each of a set of target repossession events involving a delinquent auto loan at a corresponding delinquency checkpoint during a future, checkpoint-specific temporal interval based on an application of an adaptively trained machine-learning or artificial-intelligence process to a loan-specific input dataset. As described herein, the delinquency checkpoints may include, among other things, a past-due interval of thirty-one days (e.g., two successive missed monthly payments), a past-due interval of forty-five days, and past-due interval of sixty-one days (e.g., three successive missed monthly payments), future, checkpoint-specific temporal interval may include “look-ahead window” of six months, five months, and four months associated with respective ones of the thirty-one-day delinquency checkpoint, forty-five-day delinquency checkpoint, and sixty-one-day delinquency checkpoint. Further, the target repossession events may, for example, include, but are not limited to, a repossession event without reinstatement, a reinstatement event, a skip-charge event, or a non-occurrence of any repossession event.

As described herein, the machine-learning or artificial-intelligence process may include an ensemble or decision-tree process, such as a gradient-boosted decision-tree process (e.g., the XGBoost process), and one or more of the exemplary, adaptive training processes described herein may utilize, or leverage, training datasets associated with a first prior temporal interval (e.g., a “training” interval), and validation datasets associated with a second, and distinct, prior temporal interval (e.g., an out-of-time “validation” interval). In some instances, one or more computing systems, such as, but not limited to, one or more of the distributed components of FI computing system 130, may perform one or of the steps of exemplary process 400, as described herein.

Referring to FIG. 4, FI computing system 130 may perform any of the exemplary processes described herein to receive loan data from an additional computing system associated with the financial institution, such as AF system 102B (e.g., in step 402 of FIG. 4). As described herein, each element of the loan data (e.g., structured or unstructured data records, etc.) may be associated with a corresponding delinquent auto loan product held by a customer of the financial institution, and may include, among other things, a loan identifier of the corresponding delinquent auto loan product (e.g., the alphanumeric character string, etc.), a checkpoint flag indicating that a past-due interval of the corresponding delinquent loan product represents one of the thirty-one-day, forty-five-days, or sixty-one-day delinquency checkpoints described herein, and a and a system identifier associated with a corresponding one of the additional computing systems (e.g., an IP or MAC address of AF system 102B, etc.). In some instances, FI computing system 130 may perform any of the exemplary processes described herein to store the obtained elements of loan data within a locally accessible data repository (e.g., within aggregated data store 132), and to synchronize and merge the obtained elements of loan data with one or more previously ingested elements of loan data maintained within the locally accessible data repository (e.g., also in step 402 of FIG. 4).

FI computing system 130 may perform any of the exemplary processes described herein to generate an input dataset associated with each of the customers identified by the discrete elements of the received loan data, and to apply an adaptively trained, machine-learning or artificial-intelligence process to each of the input datasets, in accordance with a predetermined temporal schedule (e.g., on a daily basis, a monthly basis, etc.), or in response to a detection of a triggering event. By way of example, and without limitation, the triggering event may correspond to a detected change in a composition of the elements of loan data maintained within aggregated data store or to a receipt of an explicit request received from AF system 102B).

For example, FI computing system 130 may obtain one or more process parameters that characterize the adaptively trained, machine-learning or artificial-intelligence process (e.g., the adaptively trained, gradient-boosted, decision-tree process described herein) and elements of composition data that specify a composition of an input dataset for the adaptively trained machine-learning or artificial-intelligence process (e.g., in step 404 of FIG. 4). In some instances, and for the adaptively trained, gradient-boosted, decision-tree process described herein, the one or more process parameters may include, but are not limited to, a learning rate associated with the adaptively trained, gradient-boosted, decision-tree process, a number of discrete decision trees included within the adaptively trained, gradient-boosted, decision-tree process (e.g., the “n_estimator” for the adaptively trained, gradient-boosted, decision-tree process), a tree depth characterizing a depth of each of the discrete decision trees included within the adaptively trained, gradient-boosted, decision-tree process, a minimum number of observations in terminal nodes of the decision trees, and/or values of one or more hyperparameters that reduce potential process overfitting (e.g., regularization of pseudo-regularization hyperparameters). Further, the elements of composition data may specify the composition of the input dataset for the adaptively trained, gradient-boosted, decision-tree process, which not only identifies the elements of loan-specific data included within each input data set dataset (e.g., input feature values, as described herein), but also a specified sequence or position of these input feature values within the input dataset.

FI computing system 130 may access filtered data records associated with one or more customers of the financial institution, and delinquent auto loan products held by these customers, and may perform any of the exemplary processes described herein to generate, for each of the delinquent auto loan products at a corresponding one of the delinquency checkpoints, an input dataset having a composition consistent with the elements of composition data (e.g., in step 406 of FIG. 4). Further, and based on the one or more obtained process parameters, FI computing system 130 may perform any of the exemplary processes described herein to apply the adaptively trained machine-learning or artificial-intelligence process to each of the generated, loan-specific input datasets (e.g., in step 408 of FIG. 4), and based on the application of the adaptively trained machine-learning or artificial-intelligence process to each of the loan-specific input datasets, FI computing system 130 may perform any of the exemplary processes described herein to generate, for each of the delinquent auto loan product at the corresponding ones of the delinquency checkpoints, loan-specific elements of output data indicative of a likelihood of an occurrence of each of a set of target repossession events during a future, checkpoint-specific temporal interval (e.g., in step 410 of FIG. 4).

For example, the adaptively trained machine-learning or artificial-intelligence process may include an adaptively trained, gradient-boosted, decision-tree process, and based on the one or more obtained process parameters, FI computing system 130 may perform operations, described herein, that establish a plurality of nodes and a plurality of decision trees for the adaptively trained, gradient-boosted, decision-tree process, each of which receive, as inputs (e.g., “ingest”), corresponding elements of the loan-specific input datasets. Based on the ingestion of the input datasets by the established nodes and decision trees of the adaptively trained, gradient-boosted, decision-tree process, FI computing system 130 may perform operations that apply the adaptively trained, gradient-boosted, decision-tree process to each of the loan-specific input datasets and that generate the loan-specific elements of the output data associated with the loan-specific input datasets.

As described herein, the target repossession events may include, but are not limited to, a repossession event without reinstatement, a reinstatement event, a skip-charge event, or a non-occurrence of any event, and the elements of output data associated with each of the delinquent auto loan products at the corresponding one of the delinquency checkpoints may include a numerical value indicative of the predicated likelihood of each of the target repossession events, e.g., with zero indicating a minimum predicted likelihood, and with unity being indicative of a maximum predicted likelihood. Further, in some instances, the numerical values associated with the target repossession events may be scaled, such that for each of the delinquent auto loan products and the corresponding one of the delinquency checkpoints, the numerical values sum to unity, e.g., indicating an expected occurrence of one of the target repossession events

In step 412 of FIG. 4, FI computing system 130 may also perform any of the exemplary processes described herein to post-process the loan-specific elements of output data and, among other things, associate each of the loan-specific elements of output data with a corresponding data record of the received loan data. In some instances, FI computing system 130 may also perform any of the exemplary processes to sort the associated data records and loan-specific elements of output data based on magnitudes of corresponding ones of the numerical scores, which indicate the predicted likelihood of an occurrence of each of a set of target repossession events during a future, checkpoint-specific temporal interval of a delinquent auto loan at a corresponding delinquency checkpoint (e.g., also in step 414 of FIG. 4). FI computing system 130 may perform any of the exemplary processes described herein to transmit all, or a selected portion of, the elements of post-processed output data across network 120 to AF system 102B (e.g., in step 416 of FIG. 4).

As described herein, AF system 102B may receive the elements of post-processed output data from FI computing system 130, and may perform any of the exemplary processes described herein to parse each of the elements of post-processed output data to obtain, for one or more of the delinquent auto loan products (at the corresponding one of the delinquency checkpoints), a corresponding numerical values indicating indicative of the predicated likelihood of the occurrence of each of the target repossession events during the future, checkpoint-specific temporal interval (e.g., the target interval Δt_{target} of four, five, or six months associated with respective ones of the thirty-one-day, forty-five-day, and sixty-one-day delinquency checkpoints described herein). Based on the obtained numerical scores, AF system 102B may perform any of the exemplary processes described herein to determine, for corresponding ones of the delinquent loan products, one or more remediation processes or treatments that, if implemented during the pending delinquency event, may resolve that pending delinquency event without any occurrence of the corresponding target repossession event. Exemplary process 400 is then complete in step 416.

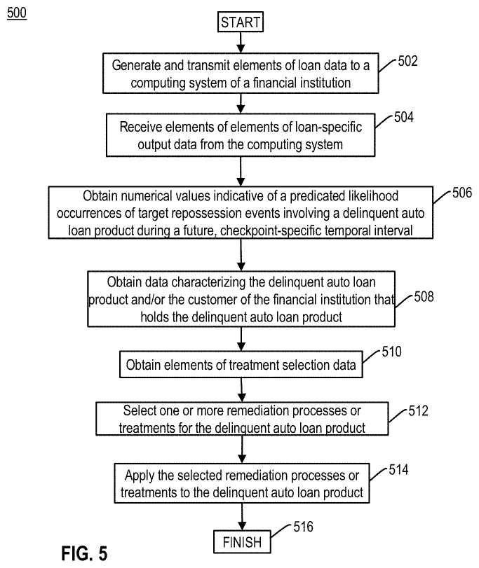

FIG. 5 is a flowchart of an exemplary process 500 for selecting and applying a remediation process associated with a delinquent auto loan product having a past-due interval associated with corresponding delinquency checkpoint based an application of a trained, machine-learning or artificial intelligence process to a loan-specific input dataset, in accordance with some examples. In some instances, one or more computing systems associated with, or operated by, a financial institution, such as, but not limited to, AF system 102B, may perform one or of the steps of exemplary process 500, as described herein.

Referring to FIG. 5, AF system 102B may perform any of the exemplary processes described herein to generate one or more elements of loan data that identify and characterize a delinquent auto loan product held by a customer of the financial institution and associated with a past-due interval equivalent to one of the delinquency checkpoints described herein (e.g., in step 502 of FIG. 5). As described herein, the delinquency checkpoints may include, among other things, a past-due interval of thirty-one days (e.g., two successive missed monthly payments), a past-due interval of forty-five days, and past-due interval of sixty-one days (e.g., three successive missed monthly payments), and the one or more elements of loan data may include, but is not limited to, a loan identifier of the delinquent auto loan product (e.g., an alphanumeric character string, etc.), a checkpoint flag identifying the corresponding one of the delinquency checkpoints associated with the past-due interval, and a system identifier of AF system 102B (e.g., an IP or MAC address, etc.). In some instances, AF system 102B may transmit the one or more element of loan data across network 120 to one or more additional computing systems associated with, or operable by, the financial institution, such as FI computing system 130 (also in step 502 of FIG. 5).

In some examples, FI computing system 130 may receive the one or more elements of loan data from AF system 102B, and may perform any of the exemplary processes described herein to generate a loan-specific input dataset associated with the delinquent auto loan product and in accordance with composition data associated with an adaptively trained, gradient-boosted, decision-tree process, and to apply the adaptively trained, gradient-boosted, decision-tree process described herein to the loan-specific input dataset. Further, and based on the application of the adaptively trained, gradient-boosted, decision-tree process described herein to the loan-specific input dataset, FI computing system 130 may perform any of the exemplary processes described herein to generate, for the delinquent auto loan product at the corresponding delinquency checkpoint, elements of loan-specific output data indicative of a predicted likelihood of an occurrence of each of a set of target repossession events during a future, checkpoint-specific temporal interval.

As described herein, the future, checkpoint-specific temporal interval may correspond to a “look-ahead window” of six months, five months, and four months associated with respective ones of the thirty-one-day delinquency checkpoint, forty-five-day delinquency checkpoint, and sixty-one-day delinquency checkpoint, and the target repossession events may include, but are not limited to, a repossession event without reinstatement, a reinstatement event, a skip-charge event, or a non-occurrence of any event. Further, the elements of output data associated with each of the delinquent auto loan product at the corresponding delinquency checkpoint may include a numerical value indicative of the predicated likelihood of the occurrence of each of the target repossession events during the future, checkpoint-specific temporal interval, e.g., with zero indicating a minimum predicted likelihood, and with unity being indicative of a maximum predicted likelihood. Further, in some instances, the numerical values associated with the target repossession events may be scaled, such that for the delinquent auto loan product at the corresponding delinquency checkpoint, the numerical values sum to unity, e.g., indicating an expected occurrence of one of the target repossession events. In some instances, FI computing system 130 may perform operations that transmit the elements of loan-specific output data across network 120 to AF system 102B.

Referring back to FIG. 5, AF system 1026 may receive the elements of loan-specific output data from FI computing system 130 and may store the elements of loan-specific output data within a locally accessible data repository (e.g., in step 504 of FIG. 5). In some instances, AF system 102B may parse the elements of loan-specific output data and obtain, for the delinquent auto loan product at the corresponding delinquent checkpoint, the numerical values indicative of the predicated likelihood of the occurrence of each of the target repossession events involving the delinquent auto loan product during the future, checkpoint-specific temporal interval (e.g., in step 506 of FIG. 5). Further, based on the loan identifier associated with the delinquent auto loan product, AF system 102B may obtain data characterizing the delinquent auto loan product (e.g., a past-due balance, a past-due interval, etc.) and in some instances, the customer of the financial institution that holds the delinquent auto loan product (e.g., in step 508 of FIG. 5).

AF system 102B may also perform operations that obtain, from one or more tangible, non-transitory memories, elements of treatment selection data that specify a likelihood-, loan-, or customer-specific criteria for selecting one, or more, of candidate remediation processes or treatments of potential applicability to the delinquent auto loan product (e.g., in step 510 of FIG. 5). In some instances, and based on an application of one or more of the likelihood-, loan-, or customer-specific criteria to the numerical values indicative of the predicated likelihood of the occurrence of each of the target repossession events during the future, checkpoint-specific temporal interval, or to portions of the data characterizing the delinquent auto loan product or the customer, AF system 102B may perform any of the exemplary processes described herein to select one or more remediation processes or treatments that, if applied to the delinquent auto loan product and/or the customer, may resolve the corresponding delinquency event without any occurrence of a target repossession event (e.g., in step 512 of FIG. 5).

For example, and based on the one or more elements of loan-specific output data, AF system 102B may determine that the delinquent auto loan product represents a substantial risk for write-off as a skip charge (e.g., characterized by a numerical score of 0.81), and minimal risks for repossession without reinstatement, reinstatement, or event non-occurrence (e.g., characterized by numerical scores of 0.08, 0.04, and 0.07, respectively). Based on this determination, AF system 102B may perform any of the exemplary processes describe herein to select remediation processes or treatments that include, but are not limited to, an enhanced diligence regarding a current location of the underlying vehicle and/or the customer that holds the delinquent auto loan product and to accelerate processes for repossession of the vehicle.

In other examples, and based on the one or more elements of loan-specific output data, AF system 102B may determine that the delinquent auto loan product, AF system 102B may determine that a customer holding the delinquent auto loan product is associated with an increased propensity for reinstatement (e.g., characterized by a numerical score of 0.91). Based on this determination, AF system 102B may perform any of the exemplary processes describe herein to select remediation processes or treatments that include, but are not limited to, enhanced digital or voice-based outreach to the customer in an effort to resolve the delinquent auto loan without advancing towards repossession or reinstatement. The disclosed embodiments are, however, not limited to these exemplary treatment applied based on corresponding ones of the predictive likelihoods of the occurrences of the target repossession events, and in other instances, AF system 102B may select and apply, or modify, any additional or alternate treatment that would be appropriate to a corresponding one of the delinquent auto loan products, the corresponding delinquency checkpoints, and the predicted likelihoods of the occurrences of each of the target repossessions events during the future, checkpoint-specific temporal intervals.

AF system 102B may also perform any of the exemplary processes described herein to apply the selected remediation processes or treatments to the delinquent auto loan product and/or the customer (e.g., in step 514 of FIG. 5). Exemplary process 500 is then complete in 524.

C. Exemplary Hardware and Software Implementations

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Exemplary embodiments of the subject matter described in this specification, including, but not limited to, application programming interfaces (APIs) 134 and 204, data ingestion engine 136, pre-processing engine 140, filtration engine 152, training engine 172, training input module 176, adaptive training and validation module 182, process input engine 212, predictive engine 228, and post-processing engine 232, can be implemented as one or more computer programs, i.e., one or more modules of computer program instructions encoded on a tangible non transitory program carrier for execution by, or to control the operation of, a data processing apparatus (or a computer system).

Additionally, or alternatively, the program instructions can be encoded on an artificially generated propagated signal, such as a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The terms “apparatus,” “device,” and “system” refer to data processing hardware and encompass all kinds of apparatus, devices, and machines for processing data, including, by way of example, a programmable processor such as a graphical processing unit (GPU) or central processing unit (CPU), a computer, or multiple processors or computers. The apparatus, device, or system can also be or further include special purpose logic circuitry, such as an FPGA (field programmable gate array) or an ASIC (application-specific integrated circuit). The apparatus, device, or system can optionally include, in addition to hardware, code that creates an execution environment for computer programs, such as code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, such as one or more scripts stored in a markup language document, in a single file dedicated to the program in question, or in multiple coordinated files, such as files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as an FPGA (field programmable gate array), an ASIC (application-specific integrated circuit), one or more processors, or any other suitable logic.

Computers suitable for the execution of a computer program include, by way of example, general or special purpose microprocessors or both, or any other kind of central processing unit. Generally, a CPU will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, such as magnetic, magneto-optical disks, or optical disks. However, a computer need not have such devices. Moreover, a computer can be embedded in another device, such as a mobile telephone, a personal digital assistant (PDA), a mobile audio or video player, a game console, a Global Positioning System (GPS) receiver, or a portable storage device, such as a universal serial bus (USB) flash drive, to name just a few.

Computer-readable media suitable for storing computer program instructions and data include all forms of non-volatile memory, media and memory devices, including by way of example semiconductor memory devices, such as EPROM, EEPROM, and flash memory devices; magnetic disks, such as internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display unit, such as a CRT (cathode ray tube) or LCD (liquid crystal display) monitor, for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, such as a data server, or that includes a middleware component, such as an application server, or that includes a front-end component, such as a computer having a graphical user interface or a web browser through which a user can interact with an implementation of the subject matter described in this specification, or any combination of one or more such back-end, middleware, or front-end components. The components of the system can be interconnected by any form or medium of digital data communication, such as a communication network. Examples of communication networks include a local area network (LAN) and a wide area network (WAN), such as the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, such as an HTML page, to a user device, such as for purposes of displaying data to and receiving user input from a user interacting with the user device, which acts as a client. Data generated at the user device, such as a result of the user interaction, can be received from the user device at the server.

While this specification includes many specifics, these should not be construed as limitations on the scope of the invention or of what may be claimed, but rather as descriptions of features specific to particular embodiments of the invention. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow. It is intended, therefore, that this disclosure and the examples herein be considered as exemplary only, with a true scope and spirit of the disclosed embodiments being indicated by the following listing of exemplary claims.

What is claimed is:

1. An apparatus, comprising:
a memory storing instructions;
a communications interface; and
at least one processor coupled to the memory and the communications interface, the at least one processor being configured to execute the instructions to:
generate an input dataset based on elements of first interaction data, the first interaction data being associated with an occurrence of a first event;
based on an application of a trained artificial intelligence process to the input dataset, generate an element of output data representative of a predicted likelihood of an occurrence of each of a plurality of second events during a target temporal interval, the target temporal interval being associated with the first event; and
transmit the elements of output data to a computing system via the communications interface, the computing system being configured to perform operations that are consistent with the elements of output data.

2. The apparatus of claim 1, wherein the at least one processor is further configured to:
receive at least a portion of the first interaction data from the computing system via the communications interface; and
store the received portion of the first interaction data within the memory.

3. The apparatus of claim 1, wherein the at least one processor is further configured to execute the instructions to:
obtain (i) one or more parameters that characterize the trained artificial intelligence process and (ii) data that characterizes a composition of the input dataset;
generate the input dataset in accordance with the data that characterizes the composition; and
apply the trained artificial intelligence process to the input dataset in accordance with the one or more parameters.

4. The apparatus of claim 1, wherein the at least one processor is further configured to execute the instructions to:
based on the data that characterizes the composition, perform operations that at least one of extract a first feature value from the first interaction data or compute a second feature value based on the first feature value; and
generate the input dataset based on at least one of the extracted first feature value or the computed second feature value.

5. The apparatus of claim 1, wherein the trained artificial intelligence process comprises a trained, gradient-boosted, decision-tree process.

6. The apparatus of claim 1, wherein the output data comprises a plurality of numerical values, each of the numerical values being indicative of the predicted likelihood of the occurrence of a corresponding one of the second events during the target temporal interval.

7. The apparatus of claim 1, wherein the at least one processor is further configured to execute the instructions to:
determine a first value of a parameter characterizing the occurrence of the first event based on the first interaction data; and
obtain targeting data associated the trained artificial intelligence process, the targeting data identifying a plurality of candidate durations of the target temporal interval, and each of the candidate durations being associated with a corresponding second value of the parameter; and
based on the first and second parameter values, establish a corresponding one of the candidate durations as the duration of the target temporal interval.

8. The apparatus of claim 1, wherein the at least one processor is further configured to execute instructions to:
perform operations that filter the first interaction data in accordance with one or more filtration criteria; and
generate the input dataset based on at least a portion of the filtered first interaction data.

9. The apparatus of claim 1, wherein the computing system is further configured to perform one or more treatment processes in accordance with the elements of the output data, the one or more treatment processes reducing the predicted likelihood of the occurrence of at least one of the second events during the targeted temporal interval.

10. The apparatus of claim 1, wherein the at least one processor is further configured to execute the instructions to:
obtain elements of second interaction data, each of the elements of the second interaction data comprising a temporal identifier associated with a temporal interval;
based on the temporal identifiers, determine that a first subset of the elements of the second interaction data are associated with a prior training interval, and that a second subset of the elements of the second interaction data are associated with a prior validation interval;
generate a plurality of training datasets based on corresponding portions of the first subset;
obtain elements of targeting data identifying each of the plurality of second events; and
perform operations that train the artificial intelligence process based on the training datasets and the targeting data.

11. The apparatus of claim 10, wherein the at least one processor is further configured to execute the instructions to:
generate a plurality of validation datasets based on portions of the second subset;
apply the trained artificial intelligence process to the plurality of validation datasets, and generate additional elements of output data based on the application of the trained artificial intelligence process to the plurality of validation datasets;
compute one or more validation metrics based on the additional elements of output data; and
based on a determined consistency between the one or more validation metrics and a threshold condition, validate the trained artificial intelligence process.

12. The apparatus of claim 1, wherein the first event corresponds to a delinquency event involving a product and each of the second events corresponding to a repossession event associated with the delinquency event and the product.

13. A computer-implemented method, comprising:
generating, using at least one processor, an input dataset based on elements of first interaction data, the first interaction data being associated with an occurrence of a first event;
based on an application of a trained artificial intelligence process to the input dataset, generating, using the at least one processor, an element of output data representative of a predicted likelihood of an occurrence of each of a plurality of second events during a target temporal interval, the target temporal interval being associated with the first event; and
transmitting, using the at least one processor, the elements of output data to a computing system, the computing system being configured to perform operations that are consistent with the elements of output data.

14. The computer-implemented method of claim 13, wherein:
the computer-implemented method further comprises:
using the at least one processor, obtraining (i) one or more parameters that characterize the trained artificial intelligence process and (ii) data that characterizes a composition of the input dataset;
based on the data that characterizes the composition, performing operations, using the at least one processor, that at least one of extract a first feature value from the first interaction data or compute a second feature value based on the first feature value; and
generating the input dataset comprises generating the input dataset based on at least one of the extracted first feature value or the computed second feature value; and
the computer-implemented method further comprises applying, using the at least one processor, the trained artificial intelligence process to the input dataset in accordance with the one or more parameters.

15. The computer-implemented method of claim 13, wherein:
the trained artificial intelligence process comprises a trained, gradient-boosted, decision-tree process; and
the output data comprises a plurality of numerical values, each of the numerical values being indicative of the predicted likelihood of the occurrence of a corresponding one of the second events during the target temporal interval.

16. The computer-implemented method of claim 13, further comprising:
determining, using the at least one processor, a first value of a parameter characterizing the occurrence of the first event based on the first interaction data; and
obtraining, using the at least one processor, targeting data associated the trained artificial intelligence process, the targeting data identifying a plurality of candidate durations of the target temporal interval, each of the candidate durations being associated with a corresponding second value of the parameter; and
based on the first and second parameter values, performing operations, using the at least one processor, that establish a corresponding one of the candidate durations as the duration of the target temporal interval.

17. The computer-implemented method of claim 13, wherein the computing system is further configured to perform one or more treatment processes in accordance with the elements of the output data, the one or more treatment processes reducing the predicted likelihood of the occurrence of at least one of the second events during the targeted temporal interval.

18. The computer-implemented method of claim 13, further comprising:
obtraining, using the at least one processor, elements of second interaction data, each of the elements of the second interaction data comprising a temporal identifier associated with a temporal interval;
based on the temporal identifiers, determining, using the at least one processor, that a first subset of the elements of the second interaction data are associated with a prior training interval, and that a second subset of the elements of the second interaction data are associated with a prior validation interval;
generating, using the at least one processor, a plurality of training datasets based on corresponding portions of the first subset;
obtraining, using the at least one processor, elements of targeting data identifying each of the plurality of second events; and
performing operations, using the at least one processor, that train the artificial intelligence process based on the training datasets and the targeting data.

19. The computer-implemented method of claim 18, further comprising:
generating, using the at least one processor, a plurality of validation datasets based on portions of the second subset;
using the at least one processor, applying the trained artificial intelligence process to the plurality of validation datasets, and generating additional elements of output data based on the application of the trained artificial intelligence process to the plurality of validation datasets;
computing, using the at least one processor, one or more validation metrics based on the additional elements of output data; and
based on a determined consistency between the one or more validation metrics and a threshold condition, validate the trained artificial intelligence process using the at least one processor.

20. A tangible, non-transitory computer-readable medium storing instructions that, when executed by at least one processor, cause the at least one processor to perform a method, comprising:
generating an input dataset based on elements of first interaction data, the first interaction data being associated with an occurrence of a first event;
based on an application of a trained artificial intelligence process to the input dataset, generating an element of output data representative of a predicted likelihood of an occurrence of each of a plurality of second events during a target temporal interval, the target temporal interval being associated with the first event; and
transmitting the elements of output data to a computing system, the computing system being configured to perform operations that are consistent with the elements of output data.
